(19) United States
(12) Patent Application Publication
(10) Pub. No.: US 2010/0250925 A1
(43) Pub. Date: Sep. 30, 2010

(54) ENCRYPTED FILE DELIVERY/RECEPTION SYSTEM, ELECTRONIC FILE ENCRYPTION PROGRAM, AND ENCRYPTED FILE DELIVERY/RECEPTION METHOD

(75) Inventors: Shin Hiraide, Tokyo (JP); Masamichi Takahashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KEYTEL CO., LTD., Tokyo (JP)

(21) Appl. No.: 12/160,676

(22) PCT Filed: Nov. 29, 2006
(86) PCT No.: PCT/JP2006/323844

§ 371 Date: Jul. 11, 2008

(30) Foreign Application Priority Data
Jan. 13, 2006 (JP) 2006-005595
May 10, 2006 (JP) 2006-131062

(51) Int. Cl. G06F 21/24; H04L 9/32

(52) U.S. Cl. 713/165

(57) ABSTRACT

An encrypted file delivery/reception system comprises a first computer, a second computer, and a password management device connected to the first and second computers through a network. The first computer has means for encrypting an electronic file to create an encrypted file. The password management device has means for storing password information including the correspondence between the decryption password for decrypting the encrypted file and telephone number of the user of the second computer, means for identifying the telephone number of the caller of a call when receiving the call with caller number notification, means for identifying the decryption password corresponding to the identified telephone number by referencing the password information, and means for transmitting the identified decryption password to the second computer. The second computer has means for decrypting the encrypted file created by the first computer by using transmitted decryption password.

### TECHNICAL FIELD

The invention is one about the password management computer, an electronic file encryption program, an encryption file delivery system and an encryption file delivery method.

### BACKGROUND ART

As usual, when encrypting a file, a person (hereinafter “an encryption person”) who encrypts a file needs to communicate a decryption password to a person (hereinafter “a decryption person”) who decrypts a file. The ways of the decryption password communications are by word of mouth, telephone, passing of the paper which the decryption password is specified to, mailing of the paper which the decryption password is specified to, sending and receiving an e-mail which the decryption password specified to, and so on. However, they have the following problems.

(1) A contact by word of mouth is not available when the encryption person is away from the decryption person geographically.

(2) A contact by telephone is not available when the decryption person can't answer a call, even the encryption person wants to tell the decryption password. Also, the contact by telephone can not available when the encryption person can't answer a call, even the decryption person wants to receive the decryption password.

(3) Passing of a paper which the decryption password is specified to is not available when the encryption person is away from the decryption person geographically.

(4) Mailing of a paper which the decryption password is specified to is not available if the decryption person must decrypt a file within the period which is shorter than the mail delivery period.

(5) Sending and receiving of the e-mail which the decryption password is specified to is available even if the encryption person is away from the decryption person geographically. Also it is available even if the telephone call between the encryption person and the decryption person can not be made. Moreover, sending and receiving the e-mail is very useful because the decryption password can be delivered within shorter period than the mail delivery period. However, if an encryption file is also delivered by sending and receiving the e-mail, there is possibility that both of an encryption file and the decryption password pass through the identical course on the Internet. Moreover, both of the encryption file and the decryption password are stored in the identical e-mail server.

Therefore, unless adopting the e-mail application which keeps confidentiality between the encryption person and the decryption person beforehand, a stranger who is not a valid decryption person can get both of the encryption file and the decryption password. For example, the stranger is an administrator of a network equipment which relayed a broadcast of the encryption file and the decryption password, and an administrator of the e-mail server, and so on. Therefore, the password communication system which solves these problems is disclosed to JP 2005-242993 A. The password communication system which is disclosed to JP 2005-242993 A communicates a password safely based on a phone caller ID.

### DISCLOSURE OF THE INVENTION

### Problems to be Solved by the Invention

However, as for the password communication system which is disclosed to JP 2005-242993 A, the following problems are left. In the concerned password communication system, it places burden on the encryption person to create the decryption password, input an encryption password to an encryption application and register of the decryption password on the password communication system. Moreover, in the password communication system, it places burden on the decryption person to input the decryption password to a decryption application. Moreover, because the decryption person hears the decryption password by sound from the concerned password communication system, he may make mistake in the hearing. Then, the decryption person must hear once again from the concerned password communication system when he hears the decryption password and makes a mistake in the hearing.

The purpose of this invention is to provide an encrypted file delivery system which is safe and convenient to solve the above-mentioned problems.

### Means for Solving the Problems

According to an exemplary embodiment of this invention, there is provided an encrypted file delivery system, comprising: at least one first computer including a processor, a memory, and an interface; at least one second computer including a processor, a memory, and an interface; and a password management computer including a processor, a memory, and an interface, the password management computer coupled to the first computer and the second computer via a network: wherein the first computer encrypts a file; wherein the password management computer stores a password information which includes a correspondence relation between a decryption password for decrypting the encrypted file and a phone number allocated an user of the second computer; wherein the password management computer receives a call with a caller ID; wherein the password management computer specifies a source phone number of the received call; wherein the password management computer refers to the password information so as to specify the decryption password corresponding to the specified source phone number; wherein the password management computer sends the specified decryption password to the second computer; and wherein the second computer decrypts the encrypted file by using the decryption password sent by the password management computer.

According to the typical embodiment form of the present invention, a file can be delivered safely and conveniently.

### BEST MODE FOR CARRYING OUT THE INVENTION

An embodiment of this invention will be described below with reference to drawings.

### The First Embodiment

FIG. 1 is a diagram which shows outline of the encrypted file delivery system in the first embodiment. The encrypted file delivery system which is shown in FIG. 1 is equipped with personal computers 10 and 20, a password management computer 3, regular phones 50 and cell phones 60. Personal computers 10 and 20 are computers which are operated by users. Also, personal computers 10 and 20 are connected with the Internet 1. Regular phones 50 and cell phones 60 are telephones which send a dial with a caller ID by user operation. Regular phones 50 and cell phones 60 may be the IP phone. In this case, a public telephone switched network 2 becomes the Internet. The password management computer 3 is connected with personal computers 10 and 20 through the Internet 1. Also, the password management computer 3 is connected by regular phones 50 and cell phones 60 through the public telephone switched network 2.

In the encrypted file delivery system in this embodiment, the personal computer 10 creates an encryption file. Then, the personal computer 10 sends a self-decryption file including the created encrypted file. The personal computer 20 receives the self-decryption file. Then, the personal computer 20 decrypts the received self-decryption file.

Incidentally, the personal computer 10 delivers the self-decryption file to the personal computer 20 by sending the e-mail including the self-decryption file to the personal computer 20. Also, delivery of the self-decryption file from the personal computer 10 from the personal computer 20 may be general way like a magnetic recording medium and so on.

FIG. 2 is a block diagram which shows the personal computer 10 which the encrypted file delivery system in the first embodiment is equipped with. The personal computer 10 is equipped with a sending/receiving device 11, a central processing device 12, a main storage device 13, an auxiliary storage device 14, an input device (omitted in the illustration) and a display device (omitted in the illustration) and so on. The sending/receiving device 11 sends and receives information and data with telephone line or the Internet. The central processing device 12 is a CPU. For example, the main storage device 13 is a memory. For example, the auxiliary storage device 14 is a hard disk. For example, the input device is a mouse or a key board. For example, the display device is a display.

FIG. 3 is a functional block diagram which shows the main storage device 13 of the personal computer 10 in the first embodiment. A file encryption program (hereinafter “an encryption program 1000”) which is component of the encrypted file delivery system in the first embodiment is stored in the auxiliary storage device 14 of the personal computer 10. When the encryption program 1000 is executed, a main module 131, a display module 132, an encryption parameter request module 133 and an encryption module 134 are stored in the main storage device 13 of the personal computer 10.

The main module 131 controls processing of the display module 132, the encryption parameter request module 133 and the encryption module 134.

The display module 132 displays an image for the encryption person to operate the encryption program 1000 on the display device that the personal computer 10 is equipped. Incidentally, the encryption person is a user who operates the personal computer 10 and instructs the personal computer 10 to encrypt a file and so on.

The encryption parameter request module 133 sends an encryption parameter request including a phone number of the decryption person to the password management computer 3. Then, the encryption parameter request module 133 acquires encryption parameters from the password management computer 3. The encryption parameters include a file ID, an encryption password and a decryption phone number. The file ID is a unique identifier of the encrypted file. The decryption phone number is a phone number with which the password management computer 3 accepts incoming call through the public telephone switched network 2, and is a phone number which is allocated for password management terminal 3 from a telecommunications carrier who manages the public telephone switched network 2.

The encryption module 134 generates the self-decryption file by encrypting a file. The encryption module 134 creates the self-decryption file by encrypting a file, adding to the encrypted file, a executing part 410 which decrypts the encrypted file, a file ID part 420 which contains the file ID and a decryption phone number part 430 which contains the decryption phone number. The file ID contained in the file ID part 420 and the decryption phone number contained in the decryption phone number part 430 were acquired by the encryption parameter request module 133.

The self-decryption file is an executable file which is possible to be decrypted even if a decryption program isn't installed in the personal computer 20 because of modules which the personal computer 20 operation system (OS) equips.

FIG. 4 is a block diagram which shows the self-decryption file 400 which is generated by the encryption program 1000 in the first embodiment. The self-decryption file 400 includes executing a part 410, a file ID part 420, a decryption phone number part 430 and a data part 440.

The file ID part 420 includes the file ID which is generated by the password management computer 3.

The decryption phone number part 430 includes the decryption phone number which is selected by the password management computer 3.

The data part 440 includes a file data (the encrypted file data) which is encrypted by the encryption module 134 which composes the encryption program 1000.

FIG. 5 is a block diagram which shows the personal computer 20 which the encrypted file delivery system in the first embodiment is equipped with. The personal computer 20 is equipped with a sending/receiving device 21, a central processing device 22, a main storage device 23, an auxiliary storage device 24, an input device (omitted in the illustration) and a display device (omitted in the illustration) and so on. The sending/receiving device 21 sends and receives information and data with the telephone line or the Internet. The central processing device 22 is a CPU. For example, the main storage device 23 is a memory. For example, the auxiliary storage device 24 is a hard disk. For example, the input device is a mouse or a key board. For example, the display device is a display.

FIG. 6 is a functional block diagram which shows the main storage device 23 of the personal computer 20 in the first embodiment. When the self-decryption file 400 is executed with the personal computer 20, the executing part 410 stores a main module 231, a display module 232, a password request module 233 and a decryption module 234 in the main storage device 23 which the personal computer 20 is equipped with.

The main module 231 controls processing of the display module 232, the password request module 233 and the decryption module 234.

The display module 232 displays an execution status of a decryption processing by the self-decryption file 400 on the display device that the personal computer 20 is equipped. Also, the display module 232 displays the decryption phone number contained in the decryption phone number part 430 of the self-decryption file 400. Incidentally, the display module 232 doesn't always have to display an execution status of decryption, and should display it appropriately as occasion demands.

The password request module 233 extracts the file ID from the file ID part 420 contained in the self-decryption file 400. Next, the password request module 233 sends the decryption password request including the extracted file ID to the password management computer 3. By this, password request module 233 receives the decryption password from the password management computer 3. Incidentally, a communications protocol based on IP (Internet Protocol) is used for communications between the personal computer 10 and the password management computer 3 through the Internet 1 and communications between the personal computer 20 and the password management computer 3 through the Internet 1. For example, a communication protocol based on the IP is SIP (Session Initiation Protocol), HTTP (Hyper Text Transfer Protocol), or e-mail protocol and so on. Also, a protocol which has security functions such as SSL (Secure Socket Layer) may be used for communications between the personal computer 10 and the password management computer 3 through the Internet 1 and communications between the personal computer 20 and the password management computer 3 through the Internet 1 to prevent from a wiretap. And, if a network 1 is not IP network like the Internet, other communication protocols may be used as far as they achieve the purpose.

Also, the password request module 233 sends the decryption password request once again when the decryption password isn't contained in a reply from the password management computer 3.

The decryption module 234 decrypts the file by the decryption password.

FIG. 7 is a block diagram which shows the cell phone 60 contained in the encrypted file delivery system in the first embodiment. The cell phone 60 is equipped with a control device 61, a sending/receiving device 62, a display device 63, a input device 64, a mike device 65 and a speaker device 66. The control device 61 controls the whole cell phone 60. The sending/receiving device 62 sends and receives various information. The display device 63 displays various information. The input device 64 helps to input various information. The mike device 65 input sounds. The speaker device 66 outputs sounds.

For example, the control device 61 directs the sending/receiving device 62 to send and receive. Also, it directs the display device 63 to display. Also, it directs the mike device 65 or the speaker device 66 to input/output sounds. Also, it directs the input part 64 to accept an entry. The sending/receiving device 62 makes a call or data communication through an antenna. Incidentally, the display device 63, the input part 64, the mike device 65 and the speaker device 66 are same as the one which usual cell phone is equipped with.

FIG. 8 is a block diagram which shows the password management computer 3 which the encrypted file delivery system in the first embodiment is equipped with. The password management computer 3 is equipped with a sending/receiving device 31, a central processing device 32, a main storage device 33, an auxiliary storage device 34, the input device (omitted in the illustration) and the display device (omitted in the illustration) and so on. For example, the password management computer 3 is a server or a personal computer. The sending/receiving device 11 sends and receives information and data through the telephone line or the Internet. For example, the central processing device 32 is a CPU. For example, the main storage device 33 is a memory. For example, the auxiliary storage device 14 is a hard disk. For example, the input device is a mouse or a keyboard. For example, the display device is a display. Also, the decryption phone number to accept a call from the decryption person is allocated for this the password management computer 3 from a telecommunications carrier who manages the public telephone switched network 2.

FIG. 9 is a block diagram which shows a transformation example of the password management computer 3 which the encrypted file delivery system in the first embodiment is equipped with. Like the concerned block diagram, the password management computer 3 may be connected to an outside storage through the sending/receiving device 31 without the auxiliary storage device 34.

FIG. 10 is a functional block diagram which shows the password management computer 3 in the first embodiment. A password management program is stored in the auxiliary storage device 34 of the password management computer 3. When the password management program is executed, a main module 331, a password generation module 332, a file ID generation module 333, a decryption phone number choice module 334, a password save module 335, an encryption parameter replying module 336, a dial incoming date save module 337, a sound guide module 338 and a password reading module 339 are stored in the main storage device 33 of the password management computer 3.

The main module 331 controls the password generation module 332, the file ID generation module 333, the decryption phone number choice module 334, the password save module 335, the encryption parameter replying module 336, the dial incoming date save module 337, the sound guide module 338 and the password reading module 339.

The password generation module 332 generates the encryption password to encrypt the file and the decryption password to decrypt the file. Specifically, the password generation module 332 randomly fixes the number of encryption password characters. Next, the password generation module 332 generates a password which consists of the fixed number of characters by choosing a character from the alphanumeric characters randomly. Incidentally, an encryption password may not be characters and may be a binary-digit-string. In this case, the password generation module 332 randomly fixes the bit-count of an encryption password. Next, the password generation module 332 generates an encryption password which consists of the fixed bit-count of binary-digit-string by choosing ON or off randomly. Incidentally, the generation-method of the password may be other ways as far as they achieve the purpose. Next, the password generation module 332 generates the decryption password to decrypt a file which is encrypted by the generated encryption password. The decryption password is fixed by a method which makes the self-decryption file 400 and is generated. The decryption password may be as same as the encryption password. The decryption password may be different from the encryption password. This depends on a cipher-method.

The file ID generation module 333 generates the file ID. The file ID is a unique identifier of the self-decryption file 400. For example, the file ID generation module 333 generates the file ID based on an application ID and a timestamp. Incidentally, the application ID is a unique identifier of a password management program which is installed in concerned the password management computer 3. Incidentally, the application ID is generally known as a license key. So, a detailed explanation is omitted. Incidentally, a generation-method of the file ID may be other ways as far as they achieves the purpose.

The decryption phone number choice module 334 selects the decryption phone number. The decryption phone numbers are managed by a decryption phone number table 342 (FIG. 11) which is stored in the auxiliary storage device 34. Incidentally, the decryption phone numbers are stored in the decryption phone number table 342 beforehand. The decryption phone number choice module 334 selects one phone number from phone numbers which are stored in the decryption phone number table 342. The decryption phone number choice module 334 may select the decryption phone number randomly, and may choose the decryption phone number according to the list of sorted phone numbers.

FIG. 11 is a diagram which shows the decryption phone number table 342 which is stored in the auxiliary storage device 34 of the password management computer 3 in the first embodiment. The decryption phone number table 342 includes decryption phone number 3421. The decryption phone number 3421 is the phone number to accept an incoming call from the cell phone 60 or the regular phone 50 which the decryption person operates. Phone numbers in the decryption phone number 3421 are allocated by the public telephone switched network 2 to the password management computer 3. Incidentally, the password management computer 3 can omit a decryption phone number table when equipped with only one decryption phone number.

Let's returns to FIG. 10 here. The encryption parameter replying module 336 sends the file ID, the encryption password and the decryption phone number to the personal computer 10. The file ID is generated by the file ID generation module 333. The encryption password is generated by the password generation module 332. The decryption phone number is selected by the decryption phone number choice module 334.

The password save module 335 relates the decryption password, the file ID, and the decryption phone number to a decryption person phone number, and stores them in a password table 341. The decryption password is generated by the password generation module 332. The file ID is generated by the file ID generation module 333. The decryption phone number is selected by the decryption phone number choice module 334. The decryption person phone number is included in the parameter request.

FIG. 12 is a diagram which shows the password table 341 which is stored in the auxiliary storage device 34 of the password management computer 3 in the first embodiment. The password table 341 includes a file ID3411, a password 3412, a phone number 3413, a decryption phone number 3414 and a dial incoming date and time 3415. The file ID3411 is a unique identifier of the self-decryption file 400. The password 3412 is the decryption password which is generated by password generation module 332. The phone number 3413 is the decryption person phone number contained in the parameter request from the personal computer 10. The decryption phone number 3414 is the decryption phone number which is selected from the decryption phone number table 342 by the decryption phone number choice module 334. Incidentally, when the password management computer 3 is equipped with only one decryption phone number, the decryption phone number 3414 can be omitted. The dial incoming date and time 3415 is date when a call incomes from phone number 3413 (the regular phone 50 or the cell phone 60) to decryption phone number 3414 of the concerned record.

Let's returns to FIG. 10 here. The dial incoming date save module 337 accepts an incoming call with a caller ID from the cell phone 60 or the regular phone 50 which is operated by the decryption person. Then, the dial incoming date save module 337 preserves incoming date and time of the concerned dial in the password table 341.

The sound guide module 338 creates speech information to inform of incoming dial acceptance. Then, the sound guide module 338 sends the created speech information to the cell phone 60 or the regular phone 50 through the sending/receiving device 31 and the public telephone switched network 2. The cell phone 60 or the regular phone 50 outputs received sound guide information from the speaker device 66. With this, the decryption person can recognize a dial acceptance. Incidentally, usual sound coding technology is used for the way of creating sound guide information. Also, the sound guide module 338 isn't necessary and the sound guide module 338 should be equipped appropriately as occasion demands. Because, the password management computer 3 can acquire a caller ID even if it only accepts a dial from the cell phone 60 or the regular phone 50. In other words, the password management computer 3 can acquire the caller ID even if it doesn't connect an incoming dial from the cell phone 60 or the regular phone 50. In this case, the sound guide module 338 is omitted.

The password reading module 339 receives the decryption password request which contains the file ID from the personal computer 20 through the sending/receiving device 31 and the Internet 1. Next, the password reading module 339 extracts the file ID from the received decryption password request. Next, password reading module 339 extracts the decryption password which is related to the extracted file ID from the password table 341. Then, password reading module 339 sends the extracted decryption password to the personal computer 20.

Next, a delivery way of the encrypted file is described using FIG. 13. FIG. 13 is the sequence chart of processing of the delivery way of the encrypted file in the first embodiment.

The encryption program 1000 is beforehand installed in the personal computer 10 (ST111).

The encryption person executes the encryption program 1000 in the personal computer 10. Then, the personal computer 10 displays a file encryption execution image which is shown in FIG. 14. The file encryption execution image is an image for the encryption person to operate the encryption program 1000.

FIG. 14 is a diagram of the file encryption execution image which is displayed in the display device of the personal computer 10 in the first embodiment. The file encryption execution image includes an encryption file field, a decryption person phone number field and an encryption execution button. A file which the encryption person wants to encrypt is specified by the encryption file field. For example, the encryption person specifies a file which he wants to encrypt by drag and drop in the encryption file field. The decryption person phone number field is input field of decryption person phone number, who is permitted to decrypt a file. When the encryption execution button is operated, the personal computer 10 executes an encryption. Incidentally, specification of an encrypted file may use other ways as far as they achieve the purpose.

When the encryption execution button is operated, the personal computer 10 gets the decryption person phone number which is inputted to the decryption person phone number field. Next, the personal computer 10 sends an encryption parameter request which includes the acquired decryption person phone number to the password management computer 3 (ST112).

When the password management computer 3 receives the encryption parameter request, it generates the encryption password and the decryption password. Next, the password management computer 3 generates the file ID. Next, the password management computer 3 selects the decryption phone number from numbers contained in the decryption phone number table 342.

Next, the password management computer 3 creates a new record in the password table 341. Next, the password management computer 3 stores the generated file ID in the file ID3411 of the created new record. Next, the password management computer 3 stores the generated decryption password in the password 3412 of the created new record. Next, the password management computer 3 stores the decryption person phone number to the phone number 3413 of the created new record, which is contained in the received parameter request. Moreover, the password management computer 3 stores the selected decryption phone number to the decryption phone number 3414 of the created new record.

Next, the password management computer 3 sends the generated file ID, the generated encryption password and the chosen decryption phone number to the personal computer 10 as a parameter request reply (ST113).

The personal computer 10 receives the file ID, the encryption and the decryption phone number. Then, the personal computer 10 generates the self-decryption file 400 using the received file ID, the received encryption password and the received decryption phone number (ST114).

The personal computer 10 sends the generated self-decryption file 400 to the personal computer 20 by e-mail and so on (ST115). Incidentally, the encryption person may deliver an magnetic recording medium which stores the generated self-decryption file 400 and so on to the decryption person. In this case, the decryption person copies the self-decryption file 400 which is stored in a received magnetic recording medium to the personal computer 20.

When the personal computer 20 receives instructions from the decryption person, it executes the self-decryption file 400. Then, the main module 231, the display module 232, the password request module 233 and the decryption module 234 are stored in the main storage device 23 of the personal computer 20 by the executing part 410 of the self-decryption file 400. Then, the personal computer 20 displays a dial request image (ST116).

FIG. 15 is a diagram of the dial request image which is displayed in the display device of the personal computer 20 in the first embodiment. The dial request image includes a decryption progress display field and a decryption phone number display field. Decryption progress of the self-decryption file 400 is displayed in the decryption progress display field. The decryption phone number contained in the decryption phone number part 430 of the self-decryption file 400 is displayed in the decryption phone number display field.

The decryption person dials the decryption phone number contained in the dial request image which is displayed in the display device of the personal computer 20 with the cell phone 60 or the regular phone 50 (ST117). I describe the case that the decryption person dials with the cell phone 60.

The password management computer 3 accepts a incoming dial from the cell phone 60. Then, the password management computer 3 acquires a caller ID, a decryption phone number at which it accepted the dial and dial incoming date and time. Next, the password management computer 3 selects records including the phone number 3413 which equals to the acquired caller ID from the password table 341. Next, the password management computer 3 selects a record including the decryption phone number 3414 which equals to the acquired decryption phone number from the selected records. Then, the password management computer 3 stores the acquired dial incoming date and time in the dial incoming date and time 3415 of the selected record (ST118). Incidentally, when the password management computer 3 selects more than one record, it stores the acquired dial incoming date and time in the dial incoming date and time 3415 of all selected records.

Next, the password management computer 3 creates a sound guide information which notifies that the password management computer 3 accepted dial incoming. Then, the password management computer 3 sends the created sound guide information to the cell phone 60 which sent the dial (ST119).

The cell phone 60 outputs the sound guide information which was received from the password management computer 3 from the speaker device 66 (S120).

On the other hand, the personal computer 20 extracts the file ID from the file ID part 420 contained in the self-decryption file 400.

Next, the personal computer 20 sends the decryption password request which includes the extracted file ID to the password management computer 3 (ST121). Incidentally, the personal computer 20 sends the decryption password request once again when the decryption password isn't included in a reply to the decryption password request. For example, the personal computer 20 sends the decryption password request by a constant interval. Also, the personal computer 20 may send the decryption password request once again immediately after receiving the reply including no decryption password. Incidentally, it is desirable that the upper limit number of sending decryption password request times is beforehand decided. For example, the personal computer 20 sends the decryption password request 10 times, in the interval of 3 seconds.

The password management computer 3 receives the decryption password request from the personal computer 20. Then, the password management computer 3 extracts the file ID from the received decryption password request. Next, the password management computer 3 selects a record including the file ID3411 which equals to the extracted file ID from the password table 341. Next, the password management computer 3 extracts the password 3412 and the dial incoming date and time 3415 from the selected record. Next, the password management computer 3 judges whether the period from the extracted dial incoming date and time 3415 to the time of extracting (password 3412 and dial incoming date and time 3415) is within a constant time. In the case within the constant time, the password management computer 3 sends a reply including the extracted password 3412 to the personal computer 20 (ST122). In other words, the password management computer 3 sends the reply including the decryption password to the personal computer 20. On the other hand, in the case exceeding the constant time, the password management computer 3 sends the reply not including the extracted password 3412 to the personal computer 20. Incidentally, the password management computer 3 may judge whether the period from the extracted dial incoming date and time 3415 to the time of receiving the decryption password request is within the constant time.

The shorter this constant time is, the safer encrypted file delivery system becomes. Because, for example, a stranger except the valid decryption person acquires the self-decryption file 400 in some way, even if the computer operated by the concerned stranger executes the self-decryption file 400, the chance that the password management computer 3 sends the decryption password is little. On the other hand, when this constant time is too short, the password management computer 3 also replies no decryption password although the personal computer 20 is operated by the valid decryption person. Therefore, the encrypted file delivery system in this embodiment becomes less convenient. For example, this constant time is 30 seconds, but it depends on this system developer who is interested in the balance of safety and convenience.

The personal computer 20 receives the reply including the decryption password from the password management computer 3. Next, the personal computer 20 decrypts the encrypted file contained in the data part 440 of the self-decryption file 400 with the received decryption password (ST123).

In the encrypted file delivery system in this embodiment, the encryption person specifies the file and the decryption person phone number, and encrypts the file. Then, the encryption person can deliver the self-decryption file including the encryption file to the decryption person with the general ways such as the e-mail or the magnetic recording medium. And, the decryption person can decrypt the self-decryption file with just a dial to the displayed phone number after executing the received self-decryption file. Therefore, without communicating the decryption password to the decryption person from the encryption person, the decryption person can decrypt the self-decryption file. In other words, the encrypted file delivery system in this embodiment can delivery the file safely and conveniently.

The personal computer 20 decrypts the self-decryption file 400 by executing the executing part 410 included in the self-decryption file 400 in the encrypted file delivery system in this embodiment.

However, the executing part 410 doesn't have to be included in the self-decryption file 400. In this case, the program which had the identical function with the executing part 410 function was installed in the personal computer 20. Then, the personal computer 20 decrypts the self-decryption file 400 by executing the concerned program.

Also, the decryption phone number part 430 doesn't have to be included in the self-decryption file 400. In this case where the password management computer 3 receives the decryption password request from the personal computer 20, the password management computer 3 sends the decryption phone number to the personal computer 20. Then, the personal computer 20 should display the dial request image contained the received decryption phone number.

Also, the password management computer 3 may be equipped with one number or more than one number for decryption phone number. The password management computer 3 may allocate the decryption phone number to every file when equipped with more than one decryption phone number. For example, the password management computer 3 can allocate the decryption phone number to every file by allocating the decryption phone number which exceeded an expiration to a new file ID. A unique decryption phone number is allocated for the encryption file by this. Therefore, the password delivery system can deliver the file more safely.

Incidentally, in the file encryption execution image (FIG. 14), more than one decryption person phone number may be entered. This place describes the case that three decryption person phone numbers are entered. In this case, the password management computer 3 creates three new records in the password table 341. Then, the password management computer 3 stores the decryption person phone number inputted to the file encryption execution image in the phone number 3413 of the created new three records. (One record contains one decryption person phone number.) Also, the password management computer 3 stores values in the file ID3411, the password 3412 and the decryption phone number 3414 of the new created three records. Those file IDs are the same. Those passwords are the same. Those decryption phone numbers are the same. In this case, when accepting an incoming dial from one of three valid decryption people, the password management computer 3 selects a record including phone number 3413 which equals to the concerned decryption person phone number. Then, the password management computer 3 stores dial incoming date and time in the dial incoming date and time 3415 of the selected record. Therefore, this password delivery system can deliver the file safely.

Moreover, the encryption program 1000 may be equipped with an address book function. The address book function is like the one which general e-mail sending/receiving software is equipped with and shows pairs of a decryption person name and a decryption person phone number. With this, in the file encryption execution image (FIG. 14), the encryption person can enter the decryption phone number easily. Incidentally, the password management computer 3 can be equipped with the address book function. In this case, the personal computer 10 sends the encryption parameter request including the decryption person name or the decryption person ID, not the decryption phone number, and so on to the password management computer 3. The decryption person ID is an unique identifier of the decryption person. Then, referring to the address book function, the password management computer 3 acquires the decryption person phone number related to a decryption name or the decryption person ID included in the received parameter request.

Moreover, the encryption program 1000 may be equipped with a group management function. The group management function manages groups and phone numbers related to each group. In the file encryption execution image (FIG. 14), the encryption person enters more than one decryption people phone number by selecting a group. Therefore, if the decryption person works for company equipped with some regular phone numbers, the group management function is useful. Because of the group management function, the decryption person can decrypt the self-decryption file 400 with any regular phone of the working company.

Also, in the first embodiment, the password management computer 3 generates the file ID, the encryption password and the decryption password. However, the encryption program 1000 of the personal computer 10 may replace the password management computer 3 and may generate the file ID, the encryption password and the decryption password. In this case, the encryption program 1000 sends the generated file ID and the generated decryption password instead of the encryption parameter request to the password management computer 3 at the step ST112. Then, the password management computer 3 stores the received file ID, the received decryption password and the received decryption person phone number in the password table 341.

Incidentally, all of the file ID, the encryption password and the decryption password don't have to be generated in either of the encryption program 1000 or the password management computer 3. In other words, the encryption program 1000 creates at least one of the file ID, the encryption password and the decryption password, and the password management computer 3 creates the rest of the file ID, the encryption password and the decryption password.

According to this embodiment, the password management computer 3 generates the decryption password. Therefore, the encryption person can omit creating the decryption password. Also, by the encryption password which the personal computer 10 received from the password management computer 3, the personal computer 10 encrypts an electronic file. Therefore, the encryption person can omit inputting the encryption password to the application. By the decryption password which the personal computer 20 received from the password management computer 3, the personal computer 20 decrypts file. Therefore, the decryption person can omit acquiring the decryption password and inputting the decryption password. By this, not like the technology of patent literature JP 2005-242993 A, the decryption person makes no mistake in hearing the decryption password. According to this embodiment, you can provide the encrypted file delivery system which is safe and convenient.

### The Second Embodiment

In the encrypted file delivery system in the first embodiment, the personal computer 20 requests the decryption password to the password management computer 3. In the encrypted file delivery system in the second embodiment, the password management computer 3 sends the decryption password to the personal computer 20 when a dial incoming arrives from the decryption person. Incidentally, the part which overlaps the encrypted file delivery system in the first embodiment omits a detailed explanation by using the same mark.

Because a composition of the encrypted file delivery system in the second embodiment is the identical encrypted file delivery system (FIG. 1) in the first embodiment, an explanation is omitted.

FIG. 16 is a functional block diagram which shows the main storage 13 of the personal computer 10 in the second embodiment. The electronic file encryption program (an encryption program 2000) which is the component of the encrypted file delivery system in the second embodiment is stored in the auxiliary storage device 14 of the personal computer 10. When the encryption program 2000 is executed, the main module 131, the display module 132, an encryption parameter request module 20133 and an encryption module 20134 are stored in the main storage 13 of the personal computer 10.

The encryption parameter request module 20133 sends the encryption parameter request including the decryption person phone number to the password management computer 3. With this, the encryption parameter is acquired by the encryption parameter request module 20133. Incidentally, the encryption parameter in the second embodiment includes a connection ID, the encryption password and the decryption phone number. Also, the connection ID is a unique identifier of user agent (UA: User Agent).

The encryption module 20134 generates the self-decryption file by encrypting the file.

Specifically, the encryption module 20134 encrypts the file which is specified by the encryption person with the encryption password which received from the encryption parameter request module 20133. Also, the encryption module 20134 adds an executing part 20410, a connection ID part 20420 containing the connection ID and the decryption phone number part 430 containing the decryption phone number to the encrypted file, so as to create the self-decryption file 20400. Incidentally, the connection ID contained in the connection ID part 20420 and the decryption phone number contained in the decryption phone number part 430 is acquired by the encryption parameter request module 20133.

FIG. 17 is a block diagram of the self-decryption file 20400 which the encryption program 2000 creates in the second embodiment generated. The self-decryption file 20400 is composed of an executing part 20410, a connection ID part 20420, the decryption phone number part 430 and the data part 440.

FIG. 18 is a functional block diagram which shows the main storage device 23 of the personal computer 20 in the second embodiment. When the self-decryption file 20400 which is generated by the encryption program 2000 is executed, the executing part 20410 stores the main module 231, the display module 232, a connection module 20233 and a decryption module 234 in the main storage device 23 of the personal computer 20.

The connection module 20233 sends a connect-request including the connection ID contained in the connection ID part 20420 of the self-decryption file 20400 to the password management computer 3. Then, the password management computer 3 connects with the personal computer 20. After that, the connection module 20233 receives the decryption password from the password management computer 3. Incidentally, it is desirable that a connection between the password management computer 3 and the personal computer 20 is cut at the constant time after the self-decryption file 20400 is executed.

FIG. 19 is a functional block diagram of the password management computer 3 in the second embodiment. The password management program is stored in the auxiliary storage device 34 of the password management computer 3. When the password management program is executed, in the main storage device 33 of the password management computer 3, the main module 331, the password generation module 332, a connection ID generation module 20333, the decryption phone number choice module 334, a password save module 20335, an encryption parameter replying module 20336, a registrar module 20337, the sound guide module 338 and a password reading notice module 20339 are stored.

The connection ID generation module 20333 generates connection ID based on the application ID and generation time of the connection ID.

Encryption parameter replying module 20336 sends the file ID, the encryption password and the decryption phone number to the personal computer 10. The file ID is generated by the connection ID generation module 20333. The encryption password is generated by the password generation module 332. The decryption phone number is selected by the decryption phone number choice module 334.

The password save module 20335 relates the decryption password generated by the password generation module 332, the connection ID generated by the connection ID generation module 20333 and the decryption phone number selected by the decryption phone number choice module 334 to the decryption person phone number included in the encryption parameter request. Then the password save module 20335 stores them in the password table 341.

FIG. 20 is a diagram of the password table 20341 stored in the auxiliary storage device 34 of the password management computer 3 in the second embodiment. The password table 341 includes a connection ID 203411, the password 3412, the phone number 3413, the decryption phone number 3414 and an IP address 203415. The connection ID 203411 is an user agent identifier generated by the connection ID generation module 20333. The password 3412 is the decryption password generated by the password generation module 332. The phone number 3413 is the decryption person phone number included in the parameter request from the personal computer 10. The decryption phone number 3414 is a phone number selected from the decryption phone number table 342 by the decryption phone number choice module 334. The IP address 203415 is an IP address of the personal computer 20 which receives the decryption password.

Let's return to FIG. 19. The registrar module 20337 receives a connect-request including the connection ID and the personal computer 20 IP address from the personal computer 20. Then, the registrar module 20337 selects a record from the password table 20341. The record has the same connection ID as the connection ID included in the received connect-request. Next, registrar module 20337 stores the IP address included in the received connect-request in the IP address 203415 of the selected record.

The password reading notice module 20339 accepts an incoming call with a caller ID from the cell phone 60 or the regular phone 50 operated by the decryption person. Then, the password reading notice module 20339 acquires the caller ID and the phone number to accept the incoming call. Next the password reading notice module 20339 sends the decryption password to the personal computer 20, which is related to the acquired caller ID and the acquired phone number to accept the incoming call.

Next, a delivery way of the encryption file is described using FIG. 21. FIG. 21 is a sequence chart of encryption file delivery in the second embodiment.

The encryption program 2000 is beforehand installed in the personal computer 10 (ST211).

The encryption person executes the encryption program 2000 in the personal computer 10. Then, the main module 131, the display module 132, the encryption parameter request module 20133 and the encryption module 20134 are stored in the main storage 13 of the personal computer 10. They are shown in FIG. 3. Then, the personal computer 10 displays the file encryption execution image (FIG. 14).

When the encryption execution button is operated, the personal computer 10 gets the decryption person phone number which is inputted to the decryption person phone number field. Next, the personal computer 10 sends the encryption parameter request including the acquired phone number to the password management computer 3 (ST212).

When the password management computer 3 receives the encryption parameter request, the password management computer 3 generates the encryption password and the decryption password. Next, the password management computer 3 generates the connection ID. Next, the password management computer 3 selects the decryption phone number from phone numbers contained in the decryption phone number table 342.

Next, the password management computer 3 creates a new record in the password table 20341. Next, the password management computer 3 stores the generated connection ID in the connection ID 203411 of the created new record. Next, the password management computer 3 stores the generated decryption password in the password 3412 of the created new record. Next, the password management computer 3 stores the generated decryption person phone number included in the received parameter request in the phone number 3413 of the created new record. Moreover, the password management computer 3 stores the selected decryption phone number to the decryption phone number 3414 of the created new record.

Next, the password management computer 3 sends the generated connection ID, the generated encryption password and the selected decryption phone number to the personal computer 10 (ST213).

The personal computer 10 receives the connection ID, the encryption password and the decryption phone number. Then, the personal computer 10 generates the self-decryption file 20400 using the received connection ID, the received encryption password and the received decryption phone number (ST214).

The personal computer 10 sends the generated self-decryption file 20400 to the personal computer 20 by e-mail and so on (ST215). Incidentally, the decryption person may deliver the magnetic recording medium which stores the generated self-decryption file 20400 and so on to the decryption person. In this case, the decryption person installs the self-decryption file 20400 stored in the received magnetic recording medium in the personal computer 20.

When the personal computer 20 receives instructions from the decryption person, the personal computer 20 executes the self-decryption file 20400. Then, the main module 231, the display module 232, the connection module 20233 and the decryption module 234 are stored in the main storage device 23 of the personal computer 20 by the executing part 20410 of the self-decryption file 20400. Then, the personal computer 20 displays the dial request image (FIG. 14) (ST216).

Next, the personal computer 20 extracts the connection ID from the connection ID part 20420 contained in the self-decryption file 20400. Next, the personal computer 20 specifies the IP address of concerned the personal computer 20. Next, the personal computer 20 sends the connect-request which includes the extracted connection ID and the specified IP address to the password management computer 3 (ST217).

The password management computer 3 receives the connect-request from the personal computer 20. Then, the password management computer 3 extracts the connection ID and the IP address from the received connect-request. Next, the password management computer 3 selects a record from password table 20341. The record has the same connection ID as the one included in the received connect-request. Next, the password management computer 3 stores the IP address extracted from the connect-request in the IP address 203415 of the selected record (ST218).

On the other hand, the decryption person call from the cell phone 60 or the regular phone 50 to the decryption phone number shown in the dial request image which is displayed in the display device of the personal computer 20 (ST219). I describe the case that the decryption person calls from the cell phone 60.

The password management computer 3 receives an incoming call from the cell phone 60. Then, the password management computer 3 acquires the caller ID and the phone number to accept the incoming call. Next, the password management computer 3 selects a record from password table 20341. The record has the same phone number in the phone number 3413 as the acquired caller ID. The record has the same phone number in the decryption phone number 3414 as the acquired number to accept the incoming call. Incidentally, the password management computer 3 does the following process to all selected records if the password management computer 3 selects more than one record. Next, the password management computer 3 extracts the connection ID 203411, the password 3412 and the IP address 203415 from the selected record. Next, the password management computer 3 judges whether or not a value is stored in the extracted IP address 203415. By this, the password management computer 3 judges whether the password management computer 3 is being connected with the personal computer 20 relating to the extracted connection ID 203411. When a value is stored in IP address 203415, the password management computer 3 knows that the password management computer 3 is being connected with during the personal computer 20. Therefore, the password management computer 3 sends the extracted password 3412 to the extracted IP address 203415. In other words, the password management computer 3 sends the decryption password to the personal computer 20 (ST220).

Next, the password management computer 3 creates sound guide information which notifies that the password management computer 3 accepted incoming call. Then, the password management computer 3 sends the created sound guide information to cell phone 60 (ST221).

Cell phone 60 outputs the sound guide information which is received from the password management computer 3 from the speaker device 66 (ST222).

On the other hand, the personal computer 20 receives the decryption password from the password management computer 3. Next, the personal computer 20 decrypts the encryption file contained in the data part 440 of the self-decryption file 20400 by the received decryption password (ST223).

Incidentally, the password management computer 3 may be equipped with one decryption phone number or may be more than one decryption phone number. The password management computer 3 may allocate the decryption phone number to every file when equipped with more than one decryption phone number. For example, the password management computer 3 can allocates a decryption phone number to every file by allocating a decryption phone number which exceeded an expiration to a new connection ID. A unique decryption phone number is allocated to the encryption file by this. Therefore, the password delivery system can deliver a file more safely.

Also, in the second embodiment, the password management computer 3 generates the connection ID, the encryption password and the decryption password. However, encryption program 2000 of the personal computer 10 may replace the password management computer 3 and may generate the connection ID, the encryption password and the decryption password. In this case, the encryption program 2000 sends the generated connection ID and the generated decryption password instead of the encryption parameter request to the password management computer 3 at the step ST212. Then, the password management computer 3 stores the received connection ID, the received decryption password and the received decryption person phone number in password table 20341.

Incidentally, all of the connection ID, the encryption password and the decryption password don't have to be generated in either of the encryption program 2000 or the password management computer 3. In other words, the encryption program 2000 creates at least one out of the connection ID, the encryption password and the decryption password, and the password management computer 3 creates the rest of the connection ID, the encryption password and the decryption password.

### Third Embodiment

In the encrypted file delivery system in the first and the second embodiment, when the password management computer 3 receives an incoming call from the decryption person, the password management computer 3 sends the decryption password related to the caller ID to the personal computer 20. However, in the encrypted file delivery system in the third embodiment, when the password management computer 3 receives the e-mail from the decryption person, the password management computer 3 sends the decryption password related to the e-mail address to the personal computer 20.

FIG. 22 is a diagram of an outline of the encrypted file delivery system in the third embodiment. The encrypted file delivery system in the third embodiment is equipped with personal computers 10 and 20 and the password management computer 3.

Incidentally, process of the personal computer 10 in the third embodiment uses a decryption person e-mail address instead of the decryption person phone number and uses a decryption e-mail address instead of the decryption phone number.

FIG. 23 is a functional block diagram which shows the main storage 13 of the personal computer 10 in the third embodiment. A file encryption program (an encryption program 3000) which is a component of the encrypted file delivery system in the third embodiment is stored in the auxiliary storage device 14 of the personal computer 10. When the encryption program 3000 is executed, the main module 131, a display module 30132, an encryption parameter request module 30133 and an encryption module 30134 are stored in the main storage 13 of the personal computer 10.

The display module 30132 displays an image for the encryption person to operate encryption program 3000 in the display device of the personal computer 10. Specifically, the display module 30132 accepts specification of a file to encrypt and the decryption person e-mail address from the encryption person.

The encryption parameter request module 30133 sends the encryption parameter request including the decryption person e-mail address to the password management computer 3. With this, the encryption parameter is acquired by the encryption parameter request module 30133. Incidentally, the encryption parameter in the third embodiment includes the file ID, the encryption password and the decryption e-mail address. The decryption e-mail address is the e-mail address of the password management computer 3.

The encryption module 30134 generates the self-decryption file by encrypting the file.

Specifically, the encryption module 30134 encrypts the file specified by the encryption person with the encryption password which is acquired by the encryption parameter request module 30133. Also, the encryption module 30134 creates the self-decryption file 30400 by adding an executing part 30410 which decrypts the encryption file, the file ID part 420 which contains the file ID and a decryption e-mail address part 30430 which contains the decryption e-mail address. Incidentally, the file ID contained in the file ID part 420 and the decryption e-mail address contained in the decryption e-mail address part 30430 are acquired by the encryption parameter request module 30133.

FIG. 24 is a block diagram of the self-decryption file 30400 which the encryption program 3000 in the third embodiment generated. The self-decryption file 30400 is composed of the executing part 30410, the file ID part 420, the decryption e-mail address part 30430 and the data part 440.

The decryption e-mail address part 30430 includes the decryption e-mail address which is selected by the password management computer 3.

FIG. 25 is a functional block diagram which shows the main storage device 23 of the personal computer 20 in the third embodiment. When the self-decryption file 30400 generated by encryption program 3000 is executed, the executing part 30410 stores the main module 231, a display module 30232, a password request module 30233 and the decryption module 234 in the main storage device 23 of the personal computer 20.

The display module 30232 displays execution status of decryption process by the self-decryption file 30400 in the display device of the personal computer 20. Incidentally, the display module 30232 doesn't have to display always execution status of decryption process and so on and should display it appropriately as occasion demands. Also, the display module 30232 displays the decryption e-mail address contained in the decryption e-mail address part 30430 of the self-decryption file 30400. Incidentally, the display module 30232 doesn't have to display always the decryption e-mail address and may display an image which demands e-mail sending permission. If display module 30232 is permitted to send the e-mail, display module 30232 reads an account ID and a password of e-mail which is set to the personal computer 20. The account ID and the password of e-mail are managed by the e-mail sending/receiving application installed in the personal computer 20 works. But, the account ID and the password of e-mail don't always have to be managed by the e-mail sending/receiving application. The account ID and the password of e-mail may be managed by the other application as far as the personal computer 20 can send the e-mail. Then, display module 30232 sends the e-mail to the decryption e-mail address.

The password request module 30233 extracts the file ID from the file ID part 420 contained in the self-decryption file 30400. Next, the password request module 30233 sends the decryption password request including the extracted file ID to the password management computer 3. By this, the password request module 30233 receives the decryption password from the password management computer 3.

FIG. 26 is a functional block diagram of the password management computer 3 in the third embodiment. The password management program is stored in the auxiliary storage device 34 of the password management computer 3. When the password management program is executed, in the main storage device 33 of the password management computer 3, the main module 331, the password generation module 332, the file ID generation module 333, a decryption e-mail address selection module 30334, a password save module 30335, an encryption parameter replying module 30336, an e-mail reception date and time save module 30337 and a password reading module 30339 are stored.

The decryption e-mail address selection module 30334 selects the decryption e-mail address from e-mail addresses of the password management computer 3. For example, the decryption e-mail address selection module 30334 selects the decryption e-mail address from a decryption e-mail address table which manages e-mail addresses of the password management computer 3. Incidentally, when the password management computer 3 is equipped with only one e-mail address, the decryption e-mail address selection module 30334 is omitted. Also, instead of decryption e-mail address selection module 30334, a decryption e-mail address creating module may be stored in the main storage device 33. The decryption e-mail address creating module creates newly a random e-mail address with which the password management computer 3 can receive the e-mail. Then, the decryption e-mail address creating module treats the new created decryption e-mail address as the decryption e-mail address.

Here, an example of decryption e-mail address generation-method is described. The decryption e-mail address creating module generates a random character string. The decryption e-mail address creating module makes the decryption e-mail address of the generated random character string and the domain which is allocated to the password management computer 3. When a random character is “eodikaoct” and a domain is “autodecode.com”, the decryption e-mail address creating module generates “eodikaoct@autodecode.com” as the decryption e-mail address. Incidentally, decryption e-mail address generation-method may be the other way as far as it achieves the purpose.

The encryption parameter replying module 30336 replies the file ID, the encryption password and the decryption e-mail address to the personal computer 10 as the encryption parameter. The file ID is generated by the file ID generation module 333. The encryption password is generated by the password generation module 332. The decryption e-mail address is selected by the decryption e-mail address selection module 30334.

The password save module 30335 relates the decryption password generated by the password generation module 332, the file ID generated by the file ID generation module 333 and the decryption e-mail address selected by the decryption e-mail address selection module 30334 to the decryption person e-mail address included in the encryption parameter request. The password save module 30335 stores them in a password table 30341 (FIG. 27) which is stored in the auxiliary storage device 34.

FIG. 27 is a diagram of the password table 30341 which is stored in the auxiliary storage device 34 of the password management computer 3 in the third embodiment. The password table 30341 includes the file ID3411, the password 3412, an e-mail address 303413, a decryption e-mail address 303414 and an e-mail reception date and time 303415. The file ID3411 is an identifier of the self-decryption file 30400, and is generated by the file ID generation module 333. The password 3412 is the decryption password which is generated by the password generation module 332. The e-mail address 303413 is the decryption person e-mail address included in the encryption parameter request from the personal computer 10. The decryption e-mail address 303414 is an e-mail address selected by the decryption e-mail address selection module 30334. Incidentally, when the password management computer 3 is equipped with only one e-mail address, the decryption e-mail address 303414 is omitted. The e-mail reception date and time 303415 is date and time when the password management computer 3 receives the e-mail from the e-mail address 303413 to the decryption e-mail address 303414.

The e-mail reception date and time save module 30337 receives the e-mail from the personal computer 20 operated by the decryption person. Incidentally, the decryption person doesn't always send the e-mail from the personal computer 20. The decryption person may send the e-mail from the other personal computer or the cell phone and so on. Then, the e-mail reception date and time save module 30337 stores e-mail reception date and time in the password table 30341. Incidentally, the e-mail reception date and time save module 30337 may judge whether or not e-mail source address is camouflaged. Then, only when the e-mail source address is judged not to be camouflaged, the e-mail reception date and time save module 30337 stores a value in the password table 30341. Incidentally, the camouflage may be judged in whatever way.

The password reading module 30339 receives the decryption password request from the personal computer 20 through the sending/receiving device 31 and the Internet 1. Next, the password reading module 30339 sends the decryption password which is related to the file ID contained in the received decryption password request to the personal computer 20.

Next, delivery way of the encryption file is described using FIG. 28. FIG. 28 is a sequence chart of an encryption file delivery process in the third embodiment.

The encryption program 3000 is beforehand installed in the personal computer 10 (ST311).

The encryption person executes the encryption program 3000 in the personal computer 10. Then, the main module 131, the display module 30132, the encryption parameter request module 30133 and the encryption module 30134 are stored in the main storage 13 of the personal computer 10. They are shown in FIG. 23. Then, the personal computer 10 displays a file encryption execution image.

The file encryption execution image is an image for the encryption person to the operate encryption program 3000. The file encryption execution image includes the encryption file field, a decryption person e-mail address field and the encryption execution button. Because the encryption file field and an encryption execution button are the same as the ones included in a file encryption execution image (FIG. 14) in the first embodiment, I omit their explanation. The decryption person e-mail address filed is input of decryption person e-mail address, the decryption person is permitted to decrypt the file.

When the encryption execution button is operated, the personal computer 10 gets the decryption person e-mail address which is inputted to the decryption person e-mail address field. Next, the personal computer 10 sends the encryption parameter request which includes the acquired decryption person e-mail address to the password management computer 3 (ST312).

When the password management computer 3 receives the encryption parameter request, the password management computer 3 generates the encryption password and the decryption password. Also, the password management computer 3 generates the file ID. Next, the password management computer 3 selects the decryption e-mail address from e-mail addresses of the password management computer 3.

Next, the password management computer 3 creates a new record in the password table 30341. Next, the password management computer 3 stores the generated file ID in the file ID3411 of the created new record. Next, the password management computer 3 stores the generated decryption password in the password 3412 of the created new record. Next, the password management computer 3 stores the decryption person e-mail address in the mail address 303413 of the created new record, which is contained in the received encryption parameter request. Moreover, the password management computer 3 stores the selected decryption e-mail address in the decryption e-mail address 303414 of the created new record.

Next, the password management computer 3 sends the generated file ID, the generated encryption password and the selected decryption e-mail address to the personal computer 10 as the reply to the parameter request (ST313).

The personal computer 10 receives the file ID, the encryption password and the decryption e-mail address. Then, the personal computer 10 generates the self-decryption file 30400 using the received file ID, the received encryption password and the received decryption e-mail address (ST314).

The personal computer 10 sends the generated self-decryption file 30400 to the personal computer 20 by e-mail and so on (ST315). Incidentally, the decryption person may deliver the magnetic recording medium which stores the generated self-decryption file 30400 to the decryption person.

When the personal computer 20 receives instructions from the decryption person, the personal computer 20 executes the self-decryption file 30400. Then, the main module 231, the display module 30232, the password request module 30233 and the decryption module 234 are stored in the main storage device 23 of the personal computer 20 by the executing part 30410 of the self-decryption file 30400. They are shown in FIG25. Then, the personal computer 20 displays an e-mail request image (ST316).

The e-mail request image includes a decryption progress display field and a decryption e-mail address display field. Decryption progress of the self-decryption file 30400 is displayed in the decryption progress display field. The decryption e-mail address contained in the decryption e-mail address part 30430 of the self-decryption file 30400 is displayed in the decryption e-mail address display field.

The decryption person sends the e-mail to the e-mail address included in the e-mail request image which is displayed in the display device of the personal computer 20 (ST317). Here, I describe the case that the decryption person sends the e-mail from the personal computer 20. Incidentally, the decryption person doesn't necessarily send the e-mail from the personal computer 20, and may send the e-mail from the cell phone or the other personal computer and so on. In this case, the encryption person inputs e-mail address such as the concerned the cell phone or the other concerned personal computer to the decryption person e-mail address field in the file encryption execution image.

The password management computer 3 receives e-mail from the personal computer 20. Then, the password management computer 3 acquires a sender e-mail address, a receiver e-mail address and e-mail reception date and time. Next, the password management computer 3 selects records including the e-mail address 303413 which equals to the acquired sender e-mail address from the password table 30341. Next, management computer 3 selects a record including the e-mail address 303414 which equals to the acquired receiver e-mail address from the selected records. Then, the password management computer 3 stores the acquired date and time in the e-mail reception date and time 303415 of the selected record (ST318). Incidentally, when the password management computer 3 selects more than one record, it stores the acquired e-mail reception date and time in the e-mail reception date and time 303415 of all selected records.

On the other hand, the personal computer 20 extracts the file ID from the file ID part 420 contained in the self-decryption file 30400 after the e-mail request image is displayed. Next, the personal computer 20 sends the decryption password request which includes the extracted file ID to the password management computer 3 (ST319). Incidentally, the personal computer 20 may send the decryption password request once again when the decryption password isn't included in the reply to the decryption password request.

The password management computer 3 receives the decryption password request from the personal computer 20. Then, the password management computer 3 extracts the file ID from the decryption password request. Next, the password management computer 3 selects a record including the file ID3411 which equals to the acquired file ID from the password table 30341. Next, the password management computer 3 extracts the password 3412 and the e-mail reception date and time 303415 from the selected record. Next, the password management computer 3 judges whether the difference between the e-mail reception date and time 303415 and the time when reception date and time 303415 is extracted is within a constant time. In the case within the constant time, the password management computer 3 sends the reply including the extracted password 3412 to the personal computer 20 (ST320). In other words, the password management computer 3 sends the reply which contains the decryption password to the personal computer 20. On the other hand, when exceeding the constant time, the password management computer 3 sends the reply not including the extracted password 3412 to the personal computer 20.

The personal computer 20 receives the reply from the password management computer 3. Next, the personal computer 20 decrypts the encryption file contained in the data part 440 of the self-decryption file 30400 using the decryption password included in the received reply (ST321).

Also, the decryption e-mail address part 30430 doesn't have to be included in the self-decryption file 30400. In this case, when the password management computer 3 receives the decryption password request from the personal computer 20, it sends the decryption e-mail address to the personal computer 20. Then, the personal computer 20 should display the e-mail request image which includes the decryption e-mail address.

Also, the password management computer 3 may be equipped with one e-mail address or more than one decryption e-mail address. When equipped with more than one decryption e-mail addresses, the password management computer 3 may allocate the decryption e-mail address every file. For example, the password management computer 3 can allocate the decryption e-mail address every file by allocating the decryption e-mail address which exceeded an expiration to a new file ID. A unique decryption e-mail address is allocated to the encryption file by this. Therefore, password delivery system can deliver the file more safely.

Incidentally, in the file encryption execution image (FIG. 14), more than one decryption people e-mail address may be entered. I describe the case that three e-mail addresses of the decryption person are entered. In this case, the password management computer 3 creates three new records in the password table 30341. Then, the password management computer 3 stores the decryption person e-mail address inputted to the file encryption execution image in the mail address 303413 of the created new three records. (One record contains one decryption person e-mail address.) Also, the password management computer 3 stores values in the file ID3411, the passwords 3412 and the decryption e-mail addresses 303414 of the created new three records. Those file IDs are same. Those passwords are the same. Those decryption e-mail addresses are the same. In this case, when the password management computer 3 receives the e-mail from one of these decryption persons, the password management computer 3 selects a record including the e-mail address 303413 which equals to the acquired sender e-mail address from the password table 30341. Then, the password management computer 3 stores date and time when it receives the e-mail in the e-mail reception date and time 303415 of the selected record. Therefore, the password delivery system can deliver the file safely.

Moreover, the encryption program 3000 may be equipped with an address book function. The address book function is like the one which general e-mail sending/receiving software is equipped with and shows pairs of a decryption person name and a decryption person e-mail address. With this, in the file encryption execution image (FIG. 14), the encryption person can enter the decryption person e-mail address easily. Incidentally, the password management computer 3 can be equipped with the address book function. In this case, the personal computer 10 sends the encryption parameter request including the decryption person name or a decryption person ID not the decryption e-mail address, and so on to the password management computer 3. Then, referring to the address book function, the password management computer 3 acquires the decryption person e-mail address related to the decryption name or the decryption person ID included in the received parameter request.

Moreover, the encryption program 3000 may be equipped with the group management function. The group management function manages groups and e-mail addresses related to each group. In the file encryption execution image, the encryption person enters more than one decryption people by selecting a group. Therefore, if the decryption person is equipped with more than one e-mail addresses, it is useful. Because of the group management function, the decryption person decrypts the self-decryption file 30400 using any his e-mail address.

Incidentally, in the third embodiment, the password management computer 3 generated the file ID, the encryption password and the decryption password. However, the encryption program 3000 of the personal computer 10 may replace the password management computer 3 and may generate the file ID, the encryption password and the decryption password. In this case, the encryption program 3000 sends the generated file ID and the generated decryption password instead of sending the encryption parameter request to the password management computer 3 at step ST312. Then, the password management computer 3 stores the received file ID, the received decryption password and the decryption person e-mail address in password table 30341.

Incidentally, all of the file ID, the encryption password and the decryption password don't have to be generated in either of the encryption program 3000 or the password management computer 3. In other words, the encryption program 3000 creates at least one of the file ID, the encryption password and the decryption password, and the password management computer 3 creates the rest of the file ID, the encryption password and the decryption password.

In the third embodiment of this invention, the personal computer 20 sends the password request like the personal computer 20 in the first embodiment. The third embodiment of this invention may follow the second embodiment. In this case, the personal computer 20 sends the connect-request to the password management computer 3. The password management computer 3 manages the connection of the personal computer 20. When the password management computer 3 receives the e-mail, it specifies a sender e-mail address of the e-mail. Next, the password management computer 3 sends the decryption password referring the specified e-mail address and state of the connection with the personal computer 20.

According to this invention in the third embodiment of this invention, the decryption person can decrypts the encryption file by only sending the e-mail to the password management computer 3.

### The Fourth Embodiment

When the password management computer 3 receives an incoming call from the decryption person in the encrypted file delivery system in the first and second embodiment, it sent the decryption password related to the caller ID to the personal computer 20. However, when the password management computer 3 in the encrypted file delivery system in the forth embodiment receives the password request from the personal computer 20, it sends the decryption password related to the IP address of the password request source to the personal computer 20.

Because a composition of the encrypted file delivery system in the forth embodiment is the same as a composition of the encrypted file delivery system (FIG. 22) in the third embodiment, a detailed explanation is omitted.

Incidentally, process of the personal computer 10 in the forth embodiment uses the decryption person name or the decryption person user ID instead of the decryption person phone number.

FIG. 29 is a functional block diagram which shows the main storage 13 of the personal computer 10 in the forth embodiment. The file encryption program (an encryption program 4000) which is the component of the encrypted file delivery system in the forth embodiment is stored in the auxiliary storage device 14. When the encryption program 4000 is executed, the main module 131, a display module 40132, an encryption parameter request module 40133 and an encryption module 40134 are stored in the main storage 13.

The display module 40132 displays an image for the encryption person to operate the encryption program 4000 in the display device. Specifically, the display module 40132 accepts a file specification to encrypt and the decryption person user ID from the encryption person. Incidentally, the display module 40132 may accept a name of the decryption person instead of the decryption person user ID. In this case, the display module 40132 refers to the decryption person manage table which shows pairs of the decryption person name and the decryption person user ID and the display module 40132 specifies the decryption person user ID related to the accepted name.

The encryption parameter request module 40133 sends the encryption parameter request including the decryption person user ID to the password management computer 3. With this, the encryption parameter is acquired by the encryption parameter request module 40133. Incidentally, the encryption parameter in the forth embodiment also includes the file ID and the encryption password.

The encryption module 40134 encrypts the file input by the encryption person with the encryption password received by the encryption parameter request module 40133. Also, the encryption module 40134 creates the self-decryption file 40400 by adding an executing part 40410 and the file ID part 420. The executing part 40410 decrypts the encryption file, The file ID part 420 contains the file ID. Incidentally, the file ID is received by the encryption parameter request module 40133.

FIG. 30 is a block diagram of the self-decryption file 40400 which the encryption program 4000 in the forth embodiment generated. The self-decryption file 40400 is composed of the executing part 40410, the file ID part 420 and the data part 440.

FIG. 31 is a functional block diagram which shows the main storage device 23 of the personal computer 20 in the forth embodiment. When the self-decryption file 40400 generated by the encryption program 4000 is executed, the executing part 40410 stores the main module 231, a display module 40232, a password request module 40233 and the decryption module 234 in the main storage device 23 of the personal computer 20.

The display module 40232 displays a decryption progress by the self-decryption file 40400 in the display device of the personal computer 20. Incidentally, the display module 40232 may be omitted.

The password request module 40233 extracts the file ID from the file ID part 420 included in the self-decryption file 40400. Next, the password request module 40233 sends the decryption password request which including the extracted file ID to the password management computer 3. By this, the password request module 40233 receives the decryption password from the password management computer 3.

FIG. 32 is a functional block diagram which shows the password management computer 3 in the forth embodiment. A password management program is stored in the auxiliary storage device 34 of the password management computer 3. When the password management program is executed, in the main storage device 33 of the password management computer 3, the main module 331, the password generation module 332, the file ID generation module 333, a decryption person IP address search module 40334, a password save module 40335, an encryption parameter replying module 40336 and a password reading module 40339 are stored.

The decryption person IP address search module 40334 searches a network address and a subnet mask from a decryption person IP address management table (FIG. 33).

FIG. 33 is a diagram which shows the decryption person IP address management table 40441 which is stored in the auxiliary storage device 34 of the password management computer 3 in the forth embodiment. The decryption person IP address management table 40441 includes a user ID 404411, an user name 404412, a network address 404413 and a subnet mask 404414. The user ID 404411 is an identifier to identify the decryption person uniquely. Also, the user name 404412 is the decryption person name. The network address 404413 is an address of a sub-net which the personal computer 20 belongs to. The subnet mask 404414 is a value to use to calculate a network address of the personal computer 20. Incidentally, records are beforehand inserted to the decryption person IP address management table 40441 in fixed way. Here, the transformation example of the decryption person IP address management table 40441 is shown. The decryption person IP address management table 40441 of the transformation example includes the IP address of the personal computer 20 instead of the network address 404413 and the subnet mask 404414.

The decryption person IP address search module 40334 extracts the decryption person name or the decryption person user ID from the parameter request. If the search module 40334 extracts the decryption person IP address, the search module 40334 selects a record from the decryption person IP address management table 40441. The record has the same user name 404412 as the name extracted from parameter request. On the other hand, if the search module 40334 extracts the decryption person user ID, the decryption person IP address search module 40334 selects a record from the decryption person IP address management table 40441. The record has the same user ID 404411 as the user ID extracted from parameter request. Next, the decryption person IP address search module 40334 extracts the network address 404413 and the subnet mask 404414 from the selected record.

The encryption parameter replying module 40336 sends the file ID generated by the file ID generation module 333 and the encryption password generated by the password generation module 332 to the personal computer 10.

The password save module 40335 stores the decryption password, the file ID, the network address 404413 and the subnet mask 404414 in a password table (FIG. 34). The decryption password is generated by the password generation module 332. The file ID is generated by the file ID generation module 333. The network address 404413 and the subnet mask 404414 is extracted by the decryption person IP address search module 40334.

FIG. 34 is a diagram which shows the password table 40341 stored in the auxiliary storage device 34 of the password management computer 3 in the forth embodiment. The password table 40341 includes the file ID3411, the password 3412, a network address 403413 and a subnet mask 403414. The file ID3411 is a identifier of the self-decryption file 40400 which is generated by the file ID generation module 333. The password 3412 is the decryption password generated by the password generation module 332. The network address 403413 is extracted by the decryption person IP address search module 40334 and is an address of a sub-net which the personal computer 20 belongs to. The subnet mask 403414 is extracted by the decryption person IP address search module 40334 and the subnet mask 403414 is a value to use to calculate a network address of the personal computer 20.

The password reading module 40339 receives the decryption password request from the personal computer 20 through the sending/receiving device 31 and the Internet 1. Next, the password reading module 40339 extracts the password related the file ID included in the received decryption password request from the password table 40341. Then, the password reading module 40339 sends the extracted password to computer 20 as the decryption password.

The transformation example of decryption person IP address management table 40441 is described. The decryption person IP address management table 40441 of the transformation example includes the IP address of the personal computer 20 instead of the network address 404413 and the subnet mask 404414. The password reading module 40339 receives the decryption password request which includes the file ID from the personal computer 20 through the sending/receiving device 31 and the Internet 1. Next, the password reading module 40339 extracts the file ID from the received decryption password request. Moreover, the password reading module 40339 specifies the source IP address from the received decryption password request. Next, the password reading module 40339 selects a record from password table 40341. The record has the same file in the file ID 3411 as the file ID which is extracted from the received decryption password request. Next, the password reading module 40339 extracts the IP address from the selected record. Next the password reading module 40339 judges whether the specified source IP address is the same as the extracted IP address. If the IP address of the specified source is not the same as the extracted IP address, the password reading module 40339 sends an error to the personal computer 20. On the other hand, if the IP address of the specified source is the same as the extracted IP address, the password reading module 40339 extracts password 3412 from the selected record. Then, the password reading module 40339 sends the extracted password 3412 to the personal computer 20 as the decryption password.

The encrypted file delivery system in this embodiment may use a MAC address Instead of the IP address. When the personal computer 20 sends the password request to the password management computer 3, the personal computer 20 adds the MAC address of the network card to a IP packet. The password management computer 3 extracts the MAC address from the IP packet. In this case, the decryption person IP address management table 40441 manages the MAC address instead of the IP address. If there is an identifier which can identify the personal computer 20 uniquely except the MAC address, the identifier may be used.

Next, the delivery way of the encryption file is described using FIG. 35. FIG. 35 is a sequence chart which shows a delivery way process of the encrypted file in the forth embodiment.

The encryption program 4000 is beforehand installed in the personal computer 10 (ST411).

The encryption person executes the encryption program 4000 in the personal computer 10. Then, the main module 131, the display module 40132, the encryption parameter request module 40133 and the encryption module 40134 are stored in the main storage 13 of the personal computer 10. Then, the personal computer 10 displays the file encryption execution image.

The file encryption execution image is the image for the encryption person to the operate encryption program 4000. The file encryption execution image includes the encryption file field, the decryption person user ID entry field and the encryption execution button. Because the encryption file field and the encryption execution button are identical with the one contained in the file encryption execution image (FIG. 14) in the first embodiment, they omit an explanation. An user ID of the decryption person who is permitted to decrypt the encryption file is inputted in the decryption person user ID entry field.

When the encryption execution button contained in the file encryption execution image is operated, the personal computer 10 acquires the decryption person user ID which was inputted in the decryption person user ID entry field contained in the file encryption execution image. Next, the personal computer 10 sends the encryption parameter request which contains the acquired decryption person user ID to the password management computer 3 (ST412).

When the password management computer 3 receives the encryption parameter request, it generates the encryption password and the decryption password. Next, the password management computer 3 generates the file ID. Next, the password management computer 3 extracts the network address 404413 and the subnet mask 404414, which are related to the decryption person, from the decryption person IP address management table 40441.

Next, the password management computer 3 creates a new record in the password table 40341. Next, the password management computer 3 stores the generated file ID in the file ID3411 of the created new record. Next, the password management computer 3 stores the generated decryption password in the password 3412 of the created new record. Next, the password management computer 3 stores the extracted network address 404413 in the network address 403413 of the created new record. Moreover, the password management computer 3 stores the extracted subnet mask 404414 in the subnet mask 403414 of the created new record.

Next, the password management computer 3 sends the generated file ID and the generated encryption password as the reply to the parameter request to the personal computer 10 (ST413).

The personal computer 10 receives the file ID and the encryption password. Then, the personal computer 10 generates the self-decryption file 40400 using the received file ID and the received encryption password (ST414).

The personal computer 10 sends the generated self-decryption file 40400 to the personal computer 20 by the e-mail and so on (ST415). Incidentally, the encryption person may deliver the magnetic recording medium which stores the generated self-decryption file 40400 and so on to the decryption person.

When the personal computer 20 receives instructions from the decryption person, it executes the self-decryption file 40400 (ST416). Then, the main module 231, the display module 40232, the password request module 40233 and the decryption module 234 are stored in the main storage device 23 of the personal computer 20 by the executing part 40410 of the self-decryption file 40400. Then, the personal computer 20 displays the execution status of the decryption processing by the self-decryption file 40400.

Next, the personal computer 20 extracts the file ID from the file ID part 420 contained in the self-decryption file 40400. Next, the personal computer 20 sends the decryption password request which contains the extracted file ID to the password management computer 3 (ST417).

The password management computer 3 receives the decryption password request from the personal computer 20. Then, the password management computer 3 extracts the file ID from the received decryption password request. Moreover, the password management computer 3 specifies the IP address of the sender from the received decryption password request. Next, the password management computer 3 selects a record from the password table 40341. The record has the same the file ID3411 as the extracted file ID. Next, the password management computer 3 extracts the network address 403413 and the subnet mask 403414 from the selected record. Next, the password management computer 3 calculates AND of the specified sender IP address and the extracted subnet mask 403414. Next, the password management computer 3 judges whether the calculated AND is the same as the extracted network address 403413. If the calculated AND is not the same as the extracted network address 403413, the password management computer 3 sends an error to the personal computer 20. On the other hand, if the calculated AND is the same as the extracted network address 403413, the password management computer 3 extracts the password 3412 from the selected record. Then, the password management computer 3 sends the reply which contains the extracted password 3412 to computer 20 (ST418). In other words, the password management computer 3 sends the reply which contains the decryption password to the personal computer 20.

The personal computer 20 receives the reply from the password management computer 3. Next, the personal computer 20 decrypts the encryption file contained in the data part 440 of the self-decryption file 40400 using the decryption password contained in the received reply (ST419).

Incidentally, in the forth embodiment, the password management computer 3 generated the file ID, the encryption password and the decryption password. However, the encryption program 4000 of the personal computer 10 may replaces the password management computer 3 and may generate the file ID, the encryption password and the decryption password. In this case, the encryption program 4000 sends the generated file ID and the generated decryption password instead of sending the encryption parameter request to the password management computer 3 at step ST412. Then, the password management computer 3 stores the received file ID and the received decryption password in the password table 40341.

Incidentally, all of the file ID, the encryption password and the decryption password don't have to be generated in either of the encryption program 4000 or the password management computer 3. In other words, the encryption program 4000 creates at least one of the file ID, the encryption password and the decryption password, and password management computer 3 creates the rest of the file ID, the encryption password and the decryption password.

According to this invention in the forth embodiment, the decryption person can decrypts the encryption file by only executing the encryption file.

The password management computer 3 in this embodiment sends the decryption password related to the IP address of the password request source to the personal computer 20. However, the password management computer 3 may send the decryption password related to unique information allocated the decryption person, which is contained in the password request to the personal computer 20. The unique information allocated the decryption person is a vein information, a fingerprint information, the voiceprint information, an ID of a FeliCa card, and an identification information of the cell phone of the decryption person.

In this case, the password table 40431 manages a correspondence relation between the decryption password and the unique information of the decryption person, instead of a correspondence relation between the decryption password and the IP address. The personal computer 20 acquires the uniquer information of the decryption person when the self-decryption file 40400 is executed. Then, the personal computer 20 sends the password request which contains the acquired unique information to the password management computer 3. If the unique information contained in the received password request agree with the unique information included in the password table 40431, the password management computer 3 sends the reply which contains the decryption password to the personal computer 20.

### Fifth Embodiment

In the encrypted file delivery system in the first embodiment, if an invalid decryption person repeats to execute the self-decryption file, self-decryption file can be decrypted. Specifically, when a proper decryption person dials to the password management computer 3, the invalid decryption person executes the self-decryption file. Then the self-decryption file is decrypted. In the encrypted file delivery system in the fifth embodiment, the encrypted file delivery system which solves above-mentioned problem is described.

The self-decryption file 400 which composes the encrypted file delivery system in the first embodiment includes the decryption phone number. The self-decryption file 50400 which composes the encrypted file delivery system in the fifth embodiment doesn't include the decryption phone number. When the self-decryption file 50400 is executed by the user of the personal computer 20, the personal computer 20 acquires the decryption phone number from the password management computer 3.

Because the composition of the encrypted file delivery system in the fifth embodiment is identical with the composition of the encrypted file delivery system (FIG. 1) in the first embodiment, it omits an explanation.

FIG. 36 is a functional block diagram which shows the main storage 13 of the personal computer 10 in the fifth embodiment. The electronic file encryption program (an encryption program 5000) which is the component of the encrypted file delivery system in the fifth embodiment is stored in the auxiliary storage device 14 of the personal computer 10. When the encryption program 5000 is executed, the main module 131, the display module 132, an encryption parameter request module 50133 and an encryption module 50134 are stored in the main storage 13 of the personal computer 10.

The encryption parameter request module 50133 sends the encryption parameter request which contains the decryption person phone number to the password management computer 3. By this, the encryption parameter request module 50133 receives the encryption parameter from the password management computer 3. Incidentally, the encryption parameter in the fifth embodiment includes the file ID and the encryption password.

The encryption module 50134 generates the self-decryption file by encrypting the file.

Specifically, the encryption module 50134 encrypts the file with the encryption password. The file is specified by the encryption person. Also, the encryption module 50134 creates a self-decryption file 50400 by adding an executing part 50410 and the file ID part 420. The executing part 50410 decrypts the encryption file. The file ID part 420 contains the file ID. The file ID contained in the file ID part 420 was acquired by the encryption parameter request module 50133.

FIG. 37 is a block diagram which is the self-decryption file 50400 which the encryption program 5000 in the fifth embodiment generated. The self-decryption file 50400 is composed of the executing part 50410, the file ID part 420 and the data part 440.

FIG. 38 is a functional block diagram which shows the main storage device 23 of the personal computer 20 in the fifth embodiment. When the self-decryption file 50400 which was generated by the encryption program 5000 is executed, the executing part 50410 stores the main module 231, a display module 50232, a password request module 50233, the decryption module 234 and a decryption phone number request module 50235 in the main storage device 23 of the personal computer 20.

The display module 50232 displays the decryption phone number in the display device of the personal computer 20. The decryption phone number was received by the decryption phone number request module 50235. Also, the display module 50232 displays the execution status of the decryption process by the self-decryption file 50400. Incidentally, the display module 50232 doesn't have to display always the execution status of the decryption and should display it appropriately as occasion demands.

The password request module 50233 extracts the file ID from the file ID part 420 contained in the self-decryption file 50400. Also, the password request module 50233 sends the decryption password request to the password management computer 3. The decryption password request contains the extracted file ID and a password request ID which the decryption phone number request module 50235 received. The password request ID is an identifier of the decryption password request. By this, the password request module 50233 receives the decryption password from the password management computer 3.

The decryption phone number request module 50235 sends the decryption phone number request to the password management computer 3. Then, the password management computer 3 sends password request ID and the decryption phone number to the personal computer 20.

FIG. 39 is a functional block diagram which shows the password management computer 3 in the fifth embodiment. A password management program is stored in the auxiliary storage device 34 of the password management computer 3. When the password management program is executed, the main module 331, the password generation module 332, the file ID generation module 333, a decryption phone number select module 50334, a password save module 50335, an encryption parameter replying module 50336, a dial incoming module 50337, the sound guide module 338, a password reading module 50339, a password request ID generation module 50340 and a decryption Phone number replying module 50341 are stored in the main storage device 33 of the password management computer 3.

The decryption phone number select module 50334 selects the decryption phone number 503421 from the phone number table 50342 (FIG. 40). Next, the decryption phone number select module 50334 allocates the selected decryption phone number to the password request ID. Next, the selected decryption phone number 503421 stores them in a decryption phone number mapping table 50343 (FIG. 41). With this, the password management computer 3 can specify the password request ID uniquely by the decryption phone number.

FIG. 40 is a diagram which shows the decryption phone number table 50342 which is stored in the auxiliary storage device 34 of the password management computer 3. The decryption phone number table 50342 includes a decryption phone number 503421 and an allocation flag 503422. The decryption phone number 503421 is the decryption phone number candidates. Therefore, all phone numbers (with which password management computer 3 can receive calls) are stored beforehand in the decryption phone number 503421. In other words, all phone numbers which the telecommunications carrier who manages public telephone switched network 2 allocated to the password management computer 3 are stored in the decryption phone number 503421. The allocation flag 503422 shows whether or not the decryption phone number 503421 is allocated to the password request ID. Specifically, when the decryption phone number 503421 is allocated to the password request ID, “1” is stored in the allocation flag 503422 of the record. On the other hand, when decryption phone number 503421 is not allocated to any request ID, “0” is stored in allocation flag 503422 of the record.

FIG. 41 is a diagram which shows a decryption phone number mapping table 50343 which is stored in the auxiliary storage of the password management computer 3. The decryption phone number mapping table 50343 includes a password request ID503431, a decryption phone number 503432 and an user phone number 503433. The password request ID 503431 is a unique identifier of the password request. The password request ID which is the generated by password request ID generation module 50340 is stored in the password request ID 503431. The decryption phone number 503432 is the phone number which was allocated to the password request which is identified by the password request ID 503431 of the record. Incidentally, the phone number which was selected by the decryption phone number select module 50334 is stored in the decryption phone number 503432. The user phone number 503433 is a phone number of a user who demands the password. The caller ID which was sent from the cell phone 60 or the regular phone 80 is stored in the user phone number 503433.

I mention how the decryption phone number select module 50334 selects the decryption phone number. The password request ID is specified uniquely by the decryption phone number. To achieve this purpose, the decryption phone number select module 50334 doesn't select the phone number which is already allocated to the password request ID from the decryption phone number table 50342. The decryption phone number select module 50334 selects a record from the decryption phone number table 50342. The record has “0” in the allocation flag 503422. Next, the decryption phone number select module 50334 extracts the decryption phone number 503421 from the selected record. Moreover, the decryption phone number select module 50334 stores “1” in the allocation flag 503422 of the selected record. Then, the decryption phone number select module 50334 allocates the extracted decryption phone number to the password request ID created by the password request ID generation module 50340. In the case where predefined time elapse after the decryption phone number select module 50334 allocates the decryption phone number 503421 to the password request, it may cancel the allocation. Also, in the case where the phone number select module 50334 sends the decryption password, it may cancel the allocation. Incidentally, the decryption phone number select module 50334 may cancel the allocation of the decryption phone number by the other opportunity. Specifically, the decryption phone number select module 50334 deletes the record in decryption phone number mapping table 50343. The record has the same decryption phone number 503421 as the decryption phone number related to allocation to be canceled. Next, the decryption phone number select module 50334 selects the record from the decryption phone number table 50342. The record has the same phone number 503421 as the decryption phone number. The decryption phone number select module 50334 cancels the allocation by storing “0” in the allocation flag 503422 of the selected record. Then, the decryption phone number select module 50334 can allocate the decryption phone number to another password request ID. The number of the passwords which the password management computer 3 can permit to send in a certain period time is not over the number of the phone numbers which were allocated by the telecommunications carrier of the public telephone switched network 2. Because, the decryption phone number select module 50334 can not allocate the decryption phone number to a password request ID when all decryption phone numbers are already allocated. So, the number of phone numbers (with which the password management computer 3 can receive calls) should be prepared according to service scale. Incidentally, the decryption phone number select module 50334 may selects the decryption phone number using the other way.

The password save module 50335 stores the decryption password, the file ID and the decryption person phone number in the password table 341 (FIG. 42). The decryption password was generated by the password generation module 332. The file ID was generated by the file ID generation module 333. The decryption person phone number was contained in the encryption parameter request.

FIG. 42 is a diagram which shows the password table 341 which is stored in the auxiliary storage device 34 of the password management computer 3 in the fifth embodiment. The password table 341 in the fifth embodiment is same as the password table (FIG. 12) in the first embodiment. But, the password table 341 in the fifth embodiment doesn't include the decryption phone number 3414 and dial incoming date and time 3415.

Let's return to FIG. 39. The encryption parameter replying module 50336 sends the file ID and the encryption password as the reply to the parameter request to the personal computer 10. The file ID was generated by the file ID generation module 333 and the encryption password was generated by the password generation module 332.

The dial incoming module 50337 accepts incoming call with caller ID from the cell phone 60 or the regular phone 50 which is operated by the decryption person. The dial incoming module 50337 acquires the caller ID and phone number at which call is received. Continuously, the dial incoming module 50337 selects the record from the decryption phone number mapping table 50343. The record has the same phone number 503432 as the acquired phone number. Next, dial incoming module 50337 stores the acquired caller ID in the user phone number 503433 of the selected record.

The password reading module 50339 receives the decryption password request from the personal computer 20. Next, the password reading module 50339 sends the password related to the received decryption password request to the personal computer 20.

The password request ID generation module 50340 receives the decryption phone number request from the personal computer 20. Then, the password request ID generation module 50340 generates the password request ID. The password request ID is the unique identifier of the decryption password request. When the password management computer 3 receives the decryption phone number requests at the same time from more than one the personal computer 20, the password management computer 3 generates password request IDs for each received decryption phone number request. They are different from each other. Also, the password management computer 3 can newly receive another decryption phone number request from the personal computer 20 during process of the decryption password request. In this case, when the password management computer 3 receives another decryption phone number request newly, the password management computer 3 generates the password request ID which is different from the generated password request ID in past time. With this, the password management computer 3 can judge more than one password requests which were sent from identical the personal computer 20 at the same time. The password request ID generation module 50340 generates the password request ID based on random number, generation date/time, and an application ID and so on. The application ID is the unique identifier of the password management program which is installed in the password management computer 3. The application ID is generally known as the license key, so I omit a detailed explanation. Incidentally, the generation-method of password request ID may use the other way as far as it achieves the purpose.

The decryption Phone number replying module 50341 sends the decryption phone number and the password request ID to the personal computer 20.

The delivery way of the encryption file is described using FIG. 43. FIG. 43 is the sequence chart of delivery way of the encryption file in the fifth embodiment.

The encryption program 5000 is beforehand installed in the personal computer 10 (ST511).

The encryption person executes encryption program 5000 in the personal computer 10. Then, the main module 131, the display module 132, the encryption parameter request module 50133 and the encryption module 50134 are stored in main storage 13 of the personal computer 10. They were shown in FIG. 36. The personal computer 10 displays the file encryption execution image (FIG. 14).

When the encryption execution button contained in the file encryption execution image is operated, the personal computer 10 gets the decryption person phone number which is inputted in the decryption person phone number entry field. Next, the personal computer 10 sends the encryption parameter request which contains the acquired decryption person phone number to the password management computer 3 (ST512).

When the password management computer 3 receives the encryption parameter request, it generates the encryption password and the decryption password. Next, the password management computer 3 generates the file ID.

Next, the password management computer 3 creates a new record in the password table 341. Next, the password management computer 3 stores the generated file in the file ID3411 of the created new record. Next, the password management computer 3 stores the generated decryption password in the password 3412 of the created new record. Next, the password management computer 3 stores the decryption person phone number which is contained in the received parameter request in the phone number 3413 of the created new record.

Next, the password management computer 3 sends the generated file ID and the generated encryption password as the reply to parameter request to the personal computer 10 (ST513).

The personal computer 10 receives the file ID and the encryption password. Then, the personal computer 10 generates the self-decryption file 50400 using the received file ID and the received encryption password (ST514).

The personal computer 10 sends the generated self-decryption file 50400 to the personal computer 20 by the e-mail and so on (ST515). Incidentally, the decryption person may deliver the magnetic recording medium which stores the generated self-decryption file 50400 and so on to the decryption person.

When the personal computer 20 receives instructions from the decryption person, it executes the self-decryption file 50400. Then, the main module 231, the display module 50232, the password request module 50233, the decryption module 234 and the decryption phone number request module 50235 are stored in the main storage device 23 of the personal computer by the executing part 50410 of the self-decryption file 50400 (ST516).

Next, the personal computer 20 sends a decryption phone number request to the password management computer 3 (ST5162).

When the password management computer 3 receives the decryption phone number request, it generates password request ID.

Next, the password management computer 3 selects the decryption phone number from the decryption phone number 503421 of the decryption phone number table 50342. Then, the password management computer 3 generates a record newly in the decryption phone number mapping table 50343. Next, the password management computer 3 stores the generated password request ID in the password request ID503431 of the new record. Moreover, the password management computer 3 stores the selected decryption phone number in the decryption phone number 503432 of the new record.

Next, the password management computer 3 sends the generated password request ID and the selected decryption phone number to the personal computer 20 (ST5163).

The personal computer 20 receives the password request ID and the decryption phone number from the password management computer 3.

Next, the personal computer 20 displays the dial request image (FIG. 15) which contains the received decryption phone number (ST5164).

The decryption person dials the decryption phone number contained in the dial request image which is displayed in the display device of the personal computer 20 with the cell phone 60 or the regular phone 50 (ST517). I describe the case that the decryption person dials with the cell phone 60.

The password management computer 3 accepts the incoming dial from the cell phone 60. Then, the password management computer 3 acquires a caller ID, and the decryption phone number at which it accepted the dial. Next, the password management computer 3 selects record including the decryption phone number 503432 which equals to the acquired decryption phone number from the decryption phone number mapping table 50343. Next, the password management computer 3 stores the acquired caller ID in the user phone number 503433 of the selected record (ST518).

Next, the password management computer 3 creates the sound guide information which notifies that the password management computer 3 accepted dial incoming. Then, the password management computer 3 sends the created sound guide information to the cell phone 60 which sent the dial (ST519).

The cell phone 60 outputs the sound guide information which was received from the password management computer 3 from the speaker device 66 (ST520).

On the other hand, the personal computer 20 extracts the file ID from the file ID part 420 contained in the self-decryption file 50400 after displaying the dial request image. Also, the personal computer 20 sends the decryption password request which includes the extracted file ID and the received password request ID to the password management computer 3 (ST521). Incidentally, the personal computer 20 may send the decryption password request once again when the decryption password isn't included in the reply to the decryption password request.

The password management computer 3 receives the decryption password request from the personal computer 20. Then, the password management computer 3 extracts the password request ID and the file ID from the received decryption password request. Next, the password management computer 3 selects a record including the password request ID503431 which equals to the extracted password request ID from the decryption phone number mapping table 50343. Then, the password management computer 3 extracts the user phone number 503433 from the selected record. Next, the password management computer 3 selects a record including the phone number 3413 which equals to the extracted user phone number 503433 from the password table 341. Incidentally, when the self-decryption file related to the extracted user phone number 503433 is more than one, more than one record is selected. Therefore, the password management computer 3 selects a record including the file ID3411 which equals to the file ID extracted from the decryption password request from the selected records. Incidentally, because the file ID is an identifier of the self-decryption file, the number of the selected record is “0” or “1”. Then, the password management computer 3 extracts the password 3412 from the selected record. Next, the password management computer 3 sends the extracted password 3412 to the personal computer 20 as the decryption password (ST522). On the other hand, if the password management computer 3 cannot select the record including the file ID3411 which equals to the extracted file ID, the password management computer 3 judges that the sending of the password is impermissible. In this case, the password management computer 3 doesn't send the password to the personal computer 20.

The personal computer 20 receives the reply including the decryption password from the password management computer 3. Next, the personal computer 20 decrypts the encryption file contained in the data part 440 of the self-decryption file 50400 with the received decryption password (ST523).

Incidentally, in the fifth embodiment, the password management computer 3 generates the file ID, the encryption password and the decryption password. However, like the first embodiment, the encryption program 5000 of the personal computer 10 may replace the password management computer 3 and may generate the file ID, the encryption password and the decryption password.

Incidentally, all of the file ID, the encryption password and the decryption password don't have to be generated in either of the encryption program 5000 or the password management computer 3. In other words, the encryption program 5000 creates at least one of the file ID, the encryption password and the decryption password, and the password management computer 3 creates the rest of the file ID, the encryption password and the decryption password.

In the fifth embodiment of this invention, like the first embodiment, the personal computer 20 sends the password request to the password management computer 3. The fifth embodiment of this invention may be same as the second embodiment. In this case, the personal computer 20 sends the connect-request to the password management computer 3. The password management computer 3 manages the connection with the personal computer 20. When the password management computer 3 accepts the dial incoming, it specifies caller ID of the accepted dial. Continuously, the password management computer 3 sends the decryption password to the personal computer 20 related to the specified called ID.

In the encrypted file delivery system in this embodiment, the password request ID is never allocated to more than one decryption password request. In other words, even if the identical self-decryption file is executed at the same time by more than one personal computer, the password request ID which is allocated to the decryption password request is different each personal computer. Therefore, if the identical self-decryption file is executed by more than one executed personal computer, the decryption phone number displayed by the display device is different respectively. Moreover, the password management computer 3 judges whether or not reply is sent based on the decryption phone number related to the password request ID and caller ID, instead of the dial incoming date and time. Therefore, in the encrypted file delivery system in the fifth embodiment, even if the person who is not a proper decryption person executes the self-decryption file, the self-decryption file isn't decrypted. In other words, you can provide the encrypted file delivery system which is safe and convenient.

In the fifth embodiment, the password management computer 3 sends the selected decryption phone number and the generated password request ID to the personal computer 20. However, the password management computer 3 may send only the decryption phone number to the personal computer 20. In this case, the password request ID503431 of the decryption phone number mapping table 50343 is omitted. Then, the personal computer 20 sends the decryption password request which contains the decryption phone number instead of the password request ID to the password management computer 3. In other words, the decryption phone number is used as the identifier for identifying the decryption password request. Then, the password management computer 3 acquires the decryption phone number from the decryption password request. Next, the password management computer 3 selects the record including the decryption phone number 503432 which equals to the acquired decryption phone number from the decryption phone number mapping table 50343. Then, the password management computer 3 extracts the user phone number 503433 from the selected record.

### Sixth Embodiment

In the encrypted file delivery system in the third embodiment, if an invalid decryption person repeats to execute the self-decryption file, self-decryption file can be decrypted. Specifically, when a proper decryption person sends the e-mail to the password management computer 3, the invalid decryption person executes the self-decryption file. Then the self-decryption file is decrypted. In the encrypted file delivery system in the sixth embodiment, the encrypted file delivery system which solves above-mentioned problem is described.

The self-decryption file 30400 which composes the encrypted file delivery system in the third embodiment includes the decryption e-mail address. The self-decryption file 60400 which composes the encrypted file delivery system in the sixth embodiment doesn't include the decryption e-mail address. When the self-decryption file 60400 is executed by the user of the personal computer 20, the personal computer 20 acquires the decryption e-mail address from the password management computer 3.

Because the composition of the encrypted file delivery system in the sixth embodiment is identical with the composition of the encrypted file delivery system (FIG. 1) in the first embodiment, it omits an explanation.

FIG. 44 is a functional block diagram which shows the main storage 13 of the personal computer 10 in the sixth embodiment. The electronic file encryption program (an encryption program 6000) which is the component of the encrypted file delivery system in the sixth embodiment is stored in the auxiliary storage device 14 of the personal computer 10. When the encryption program 6000 is executed, the main module 131, the display module 30132, an encryption parameter request module 60133 and an encryption module 60134 are stored in the main storage 13 of the personal computer 10.

The encryption parameter request module 60133 sends the encryption parameter request which contains the decryption person e-mail address to the password management computer 3. By this, encryption parameter request module 60133 acquires the encryption parameter from the password management computer 3. Incidentally, the encryption parameter in the sixth embodiment includes the file ID and the encryption password.

The encryption module 60134 generates the self-decryption file by encrypting the file.

Specifically, the encryption module 60134 encrypts the file which was specified by the encryption person with the encryption password. Also, encryption module 60134 creates the self-decryption file 60400 by adding an executing part 60410 and the file ID part 420. The executing part 60410 decrypts the encryption file. The file ID part 420 contains the file ID. The file ID contained in the file ID part 420 was acquired by the encryption parameter request module 60133.

FIG. 45 is a block diagram which is the self-decryption file 60400 which the encryption program 6000 in the sixth embodiment generated. The self-decryption file 60400 is composed of the executing part 60410, the file ID part 420 and the data part 440.

FIG. 46 is a functional block diagram which shows the main storage device 23 of the personal computer 20 in the sixth embodiment. When the self-decryption file 60400 which was generated by the encryption program 6000 is executed, the executing part 60410 stores the main module 231, the display module 30232, a password request module 60233, the decryption module 234 and an decryption e-mail address request module 60235 in the main storage device 23 of the personal computer 20.

The password request module 60233 extracts the file ID from the file ID part 420 contained in the self-decryption file 60400. Next, the password request module 60233 sends the decryption password request which contains the extracted file ID and a password request ID which the decryption e-mail address request module 60235 received to the password management computer 3. The password request ID is an unique identifier of the decryption password request. The password request ID is same as the password request ID which composes the encrypted file delivery system in the fifth embodiment. By this, the password request module 60233 receives the decryption password from the password management computer 3.

The decryption e-mail address request module 60235 sends the decryption e-mail address request to the password management computer 3. After that, the decryption e-mail address request module 60235 receives the password request ID and the decryption e-mail address from the password management computer 3.

FIG. 47 is a functional block diagram which shows the password management computer 3 in the sixth embodiment. The password management program is stored in the auxiliary storage device 34 of the password management computer 3. When the password management program is executed, the main module 331, the password generation module 332, the File ID generation module 333, a decryption e-mail address creating module 60334, a password save module 60335, an encryption parameter replying module 60336, an e-mail reception module 60337, a password reading module 60339, the password request ID generation module 50340 and a decryption e-mail address replying module 60341 are stored in the main storage device 33 of the password management computer 3.

The decryption e-mail address creating module 60334 creates newly an e-mail address of the password management computer 3. Then, The decryption e-mail address creating module 60334 allocates the created e-mail address to the password request ID which was generated by the password request ID generation module as the decryption e-mail address. Moreover, The decryption e-mail address creating module 60334 stores the password request ID and the created decryption e-mail address in the decryption e-mail address mapping table 60343 (FIG. 48). With this, the relation between the decryption e-mail address and the password request ID becomes 1-1. That is, the decryption password request is uniquely specified based on the decryption e-mail address. Incidentally, In the case where predefined time elapse after the decryption e-mail address creating module 60334 allocates the decryption e-mail address to the password request ID, it may cancel the allocation. Also, in the case where the decryption e-mail address creating module 60334 sends the decryption password, it may cancel the allocation. Also, the decryption e-mail address creating module 60334 may cancel the allocation of the decryption e-mail address by the other opportunity. In the case where the constant time after the allocation elapse, the allocation is canceled. For example, the constant time is 10-minute. The constant time is entrusted by the embodiment person of this invention.

Here, I describe the example of the generation-method of the e-mail address. The decryption e-mail address creating module 60334 creates the decryption e-mail address based on the password request ID and the domain which is allocated to the password management computer 3. When the password request ID is “38977201” and the domain is “autodecode.com”, the decryption e-mail address creating module 60334 creates “38977201@autodecode.com” as the decryption e-mail address. Because the password request ID is unique, the decryption e-mail address becomes unique, too. Incidentally, the generation-method of the decryption e-mail address doesn't have to use the always password request ID if compatible of the decryption e-mail address and the password request ID becomes 1-1. The generation-method of the decryption e-mail address may use the other way as far as it achieves the purpose.

FIG. 48 is a diagram which shows the decryption e-mail address mapping table 60343 which is stored in the auxiliary storage of the password management computer 3. The decryption e-mail address mapping table 60343 includes a password request ID603431, a decryption e-mail address 603432 and an user e-mail address 603433. The password request ID603431 is an unique identifier of the password request. Incidentally, the password request ID which is generated by the password request ID generation module 50340 is stored in password request ID603431. The decryption e-mail address 603432 is the e-mail address which was allocated to password request identified by password request ID603431 of the record. Incidentally, the e-mail address which was selected by the decryption e-mail address selection module for is stored in the decryption e-mail address 603432. The user e-mail address 603433 is the e-mail address of the user who demands the password. Incidentally, the source e-mail address of the e-mail which was sent from the personal computer 20 is stored in the user e-mail address 603433.

Here, I describe the specific way of canceling the allocation of the decryption e-mail address. For example, the decryption e-mail address is annulled by the decryption e-mail address creating module 60334. Then, the password management computer 3 cannot receive the e-mail with the decryption e-mail address. The decryption e-mail address creating module 60334 deletes a record including the decryption e-mail address 603432 which equals to the annulled decryption e-mail address. The way of canceling the allocation of the decryption e-mail address may be the other way as far as it is possible to achieve the purpose.

Also, the decryption e-mail address selection module may be stored instead of the decryption e-mail address creating module 60334 in the main storage device 33 of the password management computer 3.

The decryption e-mail address selection module selects the decryption e-mail address from a decryption e-mail address table 60342 (FIG. 49). Next, the decryption e-mail address selection module allocates the selected decryption e-mail address to the password request ID which was generated by the password request ID generation module 50340. Moreover, the decryption e-mail address selection module stores the password request ID which was generated by password request ID generation module 50340 and the selected decryption e-mail address in the decryption e-mail address mapping table 60343.

FIG. 49 is a diagram which shows the decryption e-mail address table 60342 which is stored in the auxiliary storage device 34 of the password management computer 3. The decryption e-mail address table 60342 includes a decryption e-mail address 603421 and an allocation flag 603422. The decryption e-mail address 603421 is the e-mail address which becomes the candidacy of the decryption e-mail address. All of the e-mail addresses the password management computer 3 are stored in the decryption e-mail address 603421. The allocation flag 603422 shows whether or not the decryption e-mail address 603421 is allocated to the password request ID. Specifically, when the decryption e-mail address 603421 is allocated to the password request ID, “1” is stored in the allocation flag 603422. On the other hand, when the decryption e-mail address 603421 is not allocated to any password request ID, “0” is stored in the allocation flag 603422.

I mention how the decryption e-mail address select module selects the decryption e-mail address. The password request ID is specified uniquely by the decryption e-mail address. To achieve this purpose, the decryption e-mail address selection module doesn't select the e-mail address which is already allocated to the password request ID from the decryption e-mail address table 60342. The decryption e-mail address selection module selects a record from the decryption e-mail address table 60342. The record has “0” in the allocation flag 603422. Next, the decryption e-mail address selection module extracts the decryption e-mail address 603421 from the selected record. Moreover, the decryption e-mail address selection module stores “1” in the allocation flag 603422 of the selected record. Then, the decryption e-mail address selection module allocates the extracted decryption e-mail address 603421 to the password request ID created by the password request ID generation module 50340. In the case where predefined time elapse after the decryption e-mail address selection module allocates the decryption e-mail address 603421 to the password request, it may cancel the allocation. Also, in the case where the decryption e-mail address selection module sends the decryption password, it may cancel the allocation. Incidentally, the decryption e-mail address selection module may cancel the allocation of the decryption e-mail address by the other opportunity. Specifically, the decryption e-mail address selection module deletes a record from the decryption e-mail address mapping table 60343. The record has the same decryption e-mail address 603432 as the decryption e-mail address related to allocation to be canceled. Next, the decryption e-mail address selection module selects a record from the decryption e-mail address table 60342. The record has the same the decryption e-mail address 603421 as the decryption e-mail address which cancels the allocation. The decryption e-mail address selection module cancels the allocation by storing “0” in the allocation flag 603422 of the selected record. Then, the decryption e-mail address selection module can allocate the decryption e-mail address to another password request ID. But, the number of the passwords which the password management computer 3 can permit to send in a certain period time is not over the number of the e-mail addresses of the password management computer 3. Because, the decryption e-mail address selection module can not be allocated the decryption e-mail address to the password request ID when all decryption e-mail addresses are already allocated. So, the number of e-mail addresses (with which the password management computer 3 can receive the e-mail) should be prepared according to service scale. Incidentally, the decryption e-mail address select module may selects the decryption e-mail address using the other way.

The password save module 60335 stores the decryption password, the file ID and the decryption person e-mail address in the password table 30341 (FIG. 27). The decryption password was generated by the password generation module 332. The file ID was generated by the file ID generation module 333. The decryption person e-mail address was contained in the encryption parameter request.

The password table 30341 which was stored in the auxiliary storage device 34 of the password management computer 3 in the sixth embodiment is similar to the password table 30341 (FIG. 27) which was stored in the auxiliary storage device 34 of the password management computer 3 in the third embodiment, a detailed explanation is omitted. But, the password table 30341 which was stored in the auxiliary storage device 34 of the password management computer 3 in the sixth embodiment doesn't include the decryption e-mail addresses 303414 and the e-mail reception date and time 303415.

Here, it returns to FIG. 39. The encryption parameter replying module 60336 sends the file ID which was generated by file ID generation module 333 and the encryption password which was generated by the password generation module 332 as the reply to the parameter request to the personal computer 10.

The e-mail reception module 60337 receives the e-mail from the personal computer 20 which is operated by the decryption person. Then, the e-mail reception module 60337 acquires the source e-mail address and the destination e-mail address from the received e-mail. Continuously, the e-mail reception module 60337 selects a record including the decryption e-mail address 603432 which equals to the acquired destination e-mail address from the decryption e-mail address mapping table 60343. Next, the e-mail reception module 60337 stores the acquired source e-mail address in the user e-mail address 603433 of the selected record.

The Password reading module 60339 receives the decryption password request from the personal computer 20. Next, the password reading module 60339 sends the password 3412 related to the received decryption password request to the personal computer 20.

The decryption e-mail address replying module 60341 sends the decryption e-mail address which was created by the decryption e-mail address creating module 60334 to the personal computer 20.

Next, the delivery way of the encryption file is described using FIG. 50. FIG. 50 is the sequence chart of the processing of the delivery way of the encryption file in the sixth embodiment.

The encryption program 6000 is beforehand installed in the personal computer 10 (ST611).

The encryption person executes the encryption program 6000 in the personal computer 10. Then, the main module 131, the display module 30132, the encryption parameter request module 60133 and the encryption module 60134 are stored in the main storage 13 of the personal computer 10. Then, the personal computer 10 displays the file encryption execution image.

When the encryption execution button contained in the file encryption execution image is operated, the personal computer 10 acquires the decryption person e-mail address which was inputted in the decryption person e-mail address entry field. Next, the personal computer 10 sends the encryption parameter request which contains the decryption person e-mail address to the password management computer 3 (ST612).

When the password management computer 3 receives the encryption parameter request, it generates the encryption password and the decryption password. Next, the password management computer 3 generates the file ID.

Next, the password management computer 3 creates a new record in the password table 30341. Next, the password management computer 3 stores the generated file ID in the file ID 3411 of the created new record. Next, the password management computer 3 stores the generated decryption password in the password 3412 of the created new record. Next, the password management computer 3 stores the decryption person e-mail address which is contained in the encryption parameter request in the e-mail address 3413 of the created new record.

Next, the password management computer 3 sends the generated file ID and the generated encryption password as reply to the parameter request to the personal computer 10 (ST613).

The personal computer 10 receives the file ID and the encryption password. Next, the personal computer 10 generates the self-decryption file 60400 using the received file ID and the received encryption password (ST614).

The personal computer 10 sends the generated self-decryption file 60400 to the personal computer 20 by the e-mail and so on (ST615). Incidentally, the decryption person may deliver the magnetic recording medium which stores the generated self-decryption file 60400 and so on to the decryption person.

When the personal computer 20 receives instructions from the decryption person, it executes the self-decryption file 60400. Then, the main module 231, the display module 30232, the password request module 60233, the decryption module 234 and the decryption e-mail address request module 60235 are stored in the main storage device 23 of the personal computer 20 by the executing part 60410 of the self-decryption file 60400 (ST616).

Then, the personal computer 20 sends the decryption e-mail address request to the password management computer 3 (ST6162).

When the password management computer 3 receives the decryption e-mail address request, it generates password request ID.

Next, the password management computer 3 generates a new e-mail address of the password management computer 3 as the decryption e-mail address. Then, the password management computer 3 generates a new record in the decryption e-mail address mapping table 60343. Next, the password management computer 3 stores the generated password request ID in the password request ID603431 of the new record. Moreover, the password management computer 3 stores the generated decryption e-mail address in the decryption e-mail address 603432 of the new record.

Next, the password management computer 3 sends the generated password request ID and the generated decryption e-mail address to the personal computer 20 (ST6163).

The personal computer 20 receives the password request ID and the decryption e-mail address from the password management computer 3.

Next, the personal computer 20 displays the e-mail request image which contains the received decryption e-mail address (ST6164).

The decryption person sends the e-mail to the decryption e-mail address contained in the e-mail request image which is displayed in the display device of the personal computer 20 (ST617). I describe the case where the decryption person sends e-mail from the personal computer 20. Incidentally, the decryption person may send e-mail from the cell phone or the other personal computer and so on instead of the personal computer 20. In this case, the encryption person inputs the e-mail address of the cell phone or the other personal computer to the decryption person e-mail address entry field of the file encryption execution image.

The password management computer 3 receives the e-mail from the personal computer 20. Then, the password management computer 3 acquires a source e-mail address and a destination e-mail address from the received e-mail. Next, the password management computer 3 selects a record including the decryption e-mail address 603432 which equals to the acquired destination e-mail address from the e-mail address mapping table 60343. Next, the password management computer 3 stores the acquired source e-mail address in the user e-mail address 603433 of the selected record (ST618).

On the other hand, the personal computer 20 extracts the file ID from the file ID part 420 contained in the self-decryption file 60400 after displaying the e-mail request image. Also, the personal computer 20 sends the decryption password request which contains the extracted file ID and the received password request ID to the password management computer 3 (ST619). Incidentally, the personal computer 20 may send the decryption password request once again when the decryption password isn't included in the reply to the decryption password request.

The password management computer 3 receives the decryption password request from the personal computer 20. Then, the password management computer 3 extracts the password request ID and the file ID from the received decryption password request. Next, the password management computer 3 selects a record including the password request ID603431 which equals to the extracted password request ID from the decryption e-mail address mapping table 60343. Then, the password management computer 3 extracts the user e-mail address 603433 from the selected record. Next, the password management computer 3 selects a record including the e-mail address 3413 which equals to the extracted user e-mail address 603433 from the password table 30341. When the self-decryption file related to the extracted user e-mail address 603433 is more than one, more than one record is selected. Therefore, the password management computer 3 selects a record including the file ID3411 which equals to the file ID extracted from the decryption password request from the selected records. Incidentally, because the file ID is an identifier of the self-decryption file, the number of the selected record is “0” or “1”. Then, the password management computer 3 extracts the password 3412 from the selected record. Next, the password management computer 3 sends the extracted password 3412 to the personal computer 20 as the decryption password (ST620). On the other hand, the password management computer 3 cannot select the record including the file ID3411 which equals to the extracted file ID, the password management computer 3 judges that the sending of the password is impermissible. In this case, the password management computer 3 doesn't send the password to the personal computer 20.

The personal computer 20 receives the reply including the decryption password from the password management computer 3. Then, the personal computer 20 decrypts the encryption file contained in the data part 440 of the self-decryption file 60400 with the received decryption password (ST621).

Incidentally, in the sixth embodiment, like the third embodiment, more than one decryption person e-mail address may be entered in the file encryption execution image. The encryption program 6000 may be equipped with the address book function or the group management function, like encryption program 3000.

Incidentally, in the sixth embodiment, the password management computer 3 generates the file ID, the encryption password and the decryption password. However, the encryption program 6000 of the personal computer 10 replaces the password management computer 3 and may generate the file ID, the encryption password and the decryption password.

Incidentally, all of the file ID, the encryption password and the decryption password don't have to be generated in either of the encryption program 6000 or the password management computer 3. In other words, the encryption program 6000 creates at least one of the file ID, the encryption password and the decryption password, and the password management computer 3 creates rest of the file ID, the encryption password and the decryption password.

In the sixth embodiment of this invention, like the first embodiment, the personal computer 20 sends the password request to the password management computer 3. The sixth embodiment of this invention may be same as the second embodiment. In this case, the personal computer 20 sends the connect-request to the password management computer 3. The password management computer 3 manages the connection with the personal computer 20. When the password management computer 3 receives the e-mail, it specifies the source e-mail address of the received e-mail. Continuously, the password management computer 3 sends the decryption password to the personal computer 20 related to the specified source e-mail address.

In the encrypted file delivery system in this embodiment, the password request ID is never allocated to more than one decryption password request. In other words, even if an identical self-decryption file is executed at the same time by more than one personal computer, the password request ID which is allocated to the decryption password request is different each personal computer. Therefore, if the identical self-decryption file is executed by more than one executed personal computer, the decryption e-mail address which displayed by the display device is different respectively. Moreover, the password management computer 3 judges whether or not reply is sent based on the decryption e-mail address related to the password request ID and the source e-mail address, instead of the e-mail receiving date and time. Therefore, in the encrypted file delivery system in the sixth embodiment, even if the person who is not a proper decryption person executes the self-decryption file, the self-decryption file isn't decrypted. In other words, you can provide the encrypted file delivery system which is safe and convenient.

In the sixth embodiment, the password management computer 3 sends the generated decryption e-mail address and the generated password request ID to the personal computer 20. However, the password management computer 3 may send only the generated decryption e-mail address to the personal computer 20. In this case, the password request ID603431 of the decryption e-mail address mapping table 60343 is omitted. Then, the personal computer 20 sends the decryption password request which contains the decryption e-mail address instead of the password request ID to the password management computer 3. In other words, the decryption e-mail address is used as the identifier for identifying the decryption password request. Then, the password management computer 3 acquires the decryption e-mail address from the decryption password request. Next, the password management computer 3 selects a record including the decryption e-mail address 603432 which equals to the acquired decryption e-mail address from the decryption e-mail address mapping table 60343. Then, password reading module 60339 extracts the user e-mail address 603433 from the selected record.

By the way, in the sixth embodiment, the personal computer 20 sends the e-mail to receive the decryption password. The personal computer 20 may use the communication of SIP to receive the decryption password. In this case, the personal computer 10 is equipped with the feature of the SIP user agent. Also, the password management computer 3 is equipped with the feature of the SIP user agent and the feature of the SIP server. Then, the password management computer 3 creates a decryption user agent address instead of the decryption e-mail address. The decryption user agent address is the address for the password management computer 3 to receive the communication of SIP. The detailed explanation of address form of the user agent address is omitted. The generation-method and the selection method of the decryption user agent address are similar to the generation-method and the selection method of the decryption e-mail address. Here, the overview of the processing is described. Almost, the encryption program of the personal computer 10 accepts a decryption person user agent address the instead of the decryption person e-mail address from the encryption person. The decryption person user agent address is included in the encryption parameter request module by the personal computer 10. The password management computer 3 stores the decryption person user agent address and the decryption password. Next, the password management computer 3 receives the decryption password request from the personal computer 20. Then, the password management computer 3 stores the generated password request ID and the generated decryption user agent address in the decryption e-mail address mapping table. Incidentally, the decryption e-mail address mapping table includes the decryption user agent address instead of the decryption e-mail address 603432 and includes the user agent address of the user instead of user e-mail address 603433. The personal computer 20 sends a signaling to the decryption user agent address with SIP. The password management computer 3 receives the signaling from the personal computer 20. The password management computer 3 specifies a source user agent address and a destination user agent address from the received signaling. Next, the password management computer 3 selects a record including the decryption user agent address which equals to the specified destination user agent address from the decryption e-mail address mapping table. Next, the password management computer 3 stores the specified source user agent address in the user agent address of the user of the selected record. By this, the password management computer 3 stores correspondence relation between the user agent address of the user and the password request ID in the decryption e-mail address mapping table. The other processes are same as the above-mentioned processes.

This invention isn't limited to the above-mentioned embodiment and can implement by changing some kinds. Specifically, the password management computer 3 may be composed by more than one computer system according to the number of the users. Also, the feature of each module which was stored at the main storage device 33 may be distributed to more than one computer system.

### BRIEF DESCRIPTION OF THE DRAWINGS

FIG. 1 is a diagram which shows outline of a encrypted file delivery system in a first embodiment.

FIG. 2 is a block diagram which shows a personal computer which the encrypted file delivery system in the first embodiment is equipped with.

FIG. 3 is a functional block diagram which shows a main storage device of the personal computer in the first embodiment.

FIG. 4 is a block diagram which shows a self-decryption file which is generated by an encryption program in the first embodiment.

FIG. 5 is a block diagram which shows a personal computer which the encrypted file delivery system in the first embodiment is equipped with.

FIG. 6 is a functional block diagram which shows a main storage device of the personal computer in the first embodiment.

FIG. 7 is a block diagram which shows a cell phone contained in the encrypted file delivery system in the first embodiment.

FIG. 8 is a block diagram which shows a password management computer which the encrypted file delivery system in the first embodiment is equipped with.

FIG. 9 is a block diagram which shows a transformation example of the password management computer which the encrypted file delivery system in the first embodiment is equipped with.

FIG. 10 is a functional block diagram which shows the password management computer in the first embodiment.

FIG. 11 is a diagram which shows a decryption phone number table which is stored in an auxiliary storage device of the password management computer in the first embodiment.

FIG. 12 is a diagram which shows a password table which is stored in an auxiliary storage device of the password management computer in the first embodiment.

FIG. 13 is the sequence chart of processing of a delivery way of the encrypted file in the first embodiment.

FIG. 14 is a diagram of the file encryption execution image which is displayed in a display device of the personal computer in the first embodiment.

FIG. 15 is a diagram of the dial request image which is displayed in a display device of the personal computer in the first embodiment.

FIG. 16 is a functional block diagram which shows a main storage of the personal computer in the second embodiment.

FIG. 17 is a block diagram of a self-decryption file which an encryption program creates in the second embodiment generated.

FIG. 18 is a functional block diagram which shows the main storage device of the personal computer in the second embodiment.

FIG. 19 is a functional block diagram of the password management computer in the second embodiment.

FIG. 20 is a diagram of a password table stored in the auxiliary storage device of the password management computer in the second embodiment.

FIG. 21 is a sequence chart of encryption file delivery in the second embodiment.

FIG. 22 is a diagram of an outline of the encrypted file delivery system in the third embodiment.

FIG. 23 is a functional block diagram which shows the main storage of the personal computer in the third embodiment.

FIG. 24 is a block diagram of a self-decryption file which an encryption program in the third embodiment generated.

FIG. 25 is a functional block diagram which shows the main storage device of the personal computer in the third embodiment.

FIG. 26 is a functional block diagram of the password management computer in the third embodiment.

FIG. 27 is a diagram of a password table which is stored in the auxiliary storage device of the password management computer in the third embodiment.

FIG. 28 is a sequence chart of an encryption file delivery process in the third embodiment.

FIG. 29 is a functional block diagram which shows the main storage of the personal computer in the forth embodiment.

FIG. 30 is a block diagram of a self-decryption file which an encryption program in the forth embodiment generated.

FIG. 31 is a functional block diagram which shows the main storage device of the personal computer in the forth embodiment.

FIG. 32 is a functional block diagram which shows the password management computer in the forth embodiment.

FIG. 33 is a diagram which shows a decryption person IP address management table which is stored in the auxiliary storage device of the password management computer in the forth embodiment.

FIG. 34 is a diagram which shows a password table stored in the auxiliary storage device of the password management computer in the forth embodiment.

FIG. 35 is a sequence chart which shows a delivery way process of the encrypted file in the forth embodiment.

FIG. 36 is a functional block diagram which shows the main storage of the personal computer in the fifth embodiment.

FIG. 37 is a block diagram which is a self-decryption file which an encryption program in the fifth embodiment generated.

FIG. 38 is a functional block diagram which shows the main storage device of the personal computer in the fifth embodiment.

FIG. 39 is a functional block diagram which shows the password management computer in the fifth embodiment.

FIG. 40 is a diagram which shows a decryption phone number table which is stored in the auxiliary storage device of the password management computer.

FIG. 41 is a diagram which shows a decryption phone number mapping table which is stored in the auxiliary storage of the password management computer.

FIG. 42 is a diagram which shows the password table which is stored in the auxiliary storage device of the password management computer in the fifth embodiment.

FIG. 43 is the sequence chart of delivery way of the encryption file in the fifth embodiment.

FIG. 44 is a functional block diagram which shows the main storage of the personal computer in the sixth embodiment.

FIG. 45 is a block diagram which is a self-decryption file which an encryption program in the sixth embodiment generated.

FIG. 46 is a functional block diagram which shows the main storage device of the personal computer in the sixth embodiment.

FIG. 47 is a functional block diagram which shows the password management computer in the sixth embodiment.

FIG. 48 is a diagram which shows a decryption e-mail address mapping table which is stored in the auxiliary storage of the password management computer.

FIG. 49 is a diagram which shows decryption e-mail address table which is stored in the auxiliary storage device of the password management computer.

FIG. 50 is the sequence chart of the processing of the delivery way of the encryption file in the sixth embodiment.

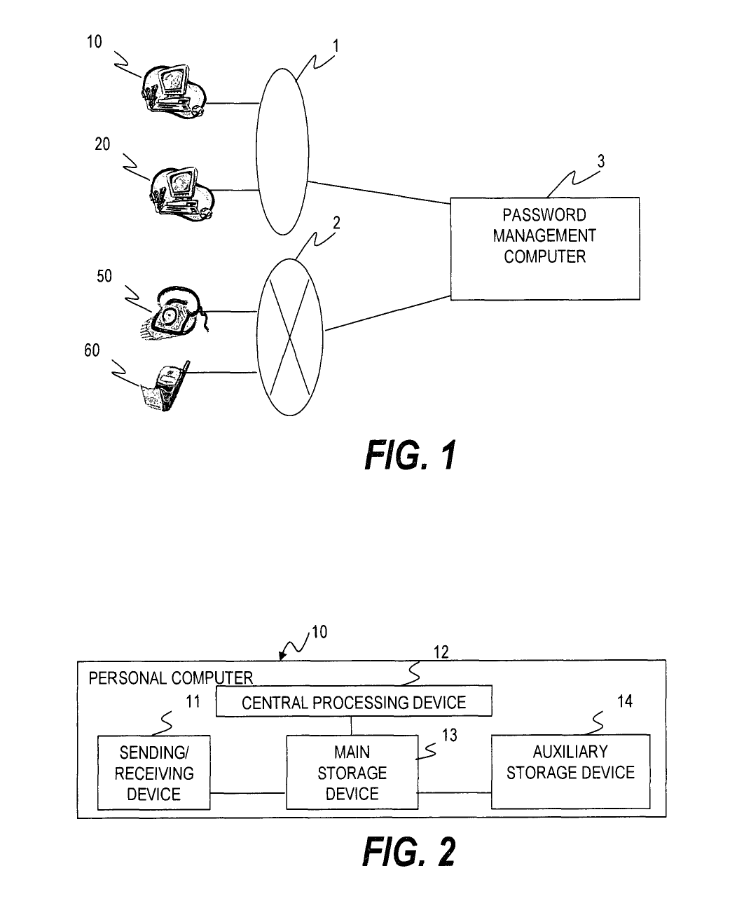

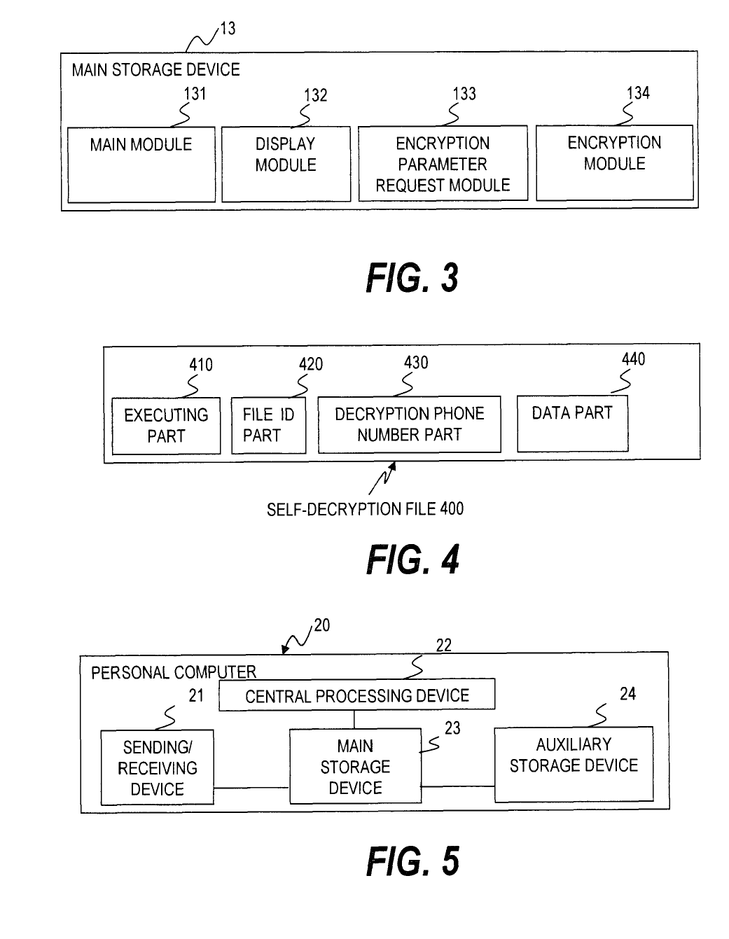

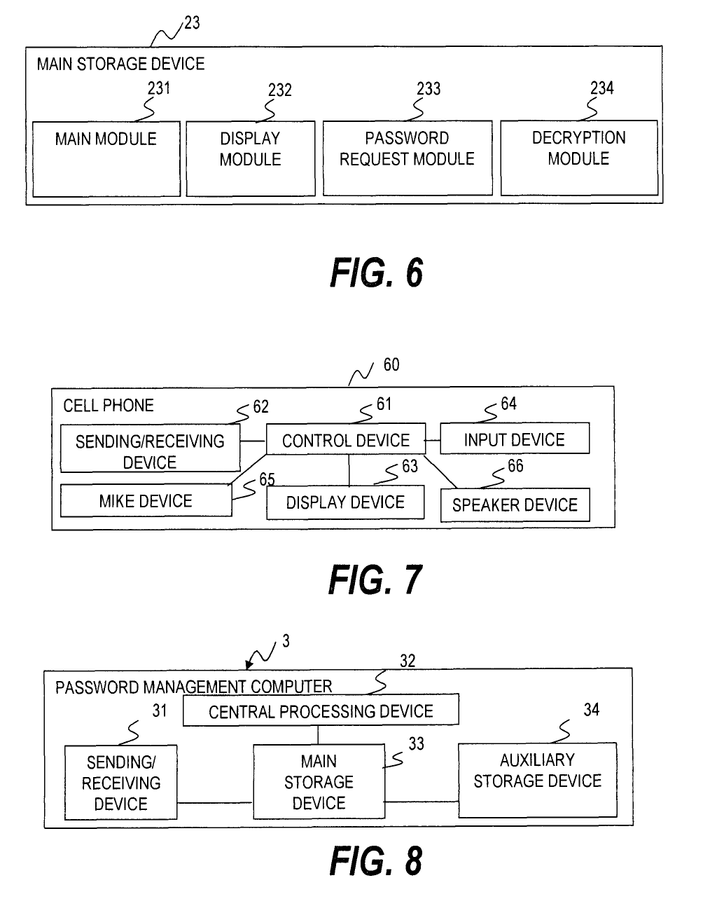

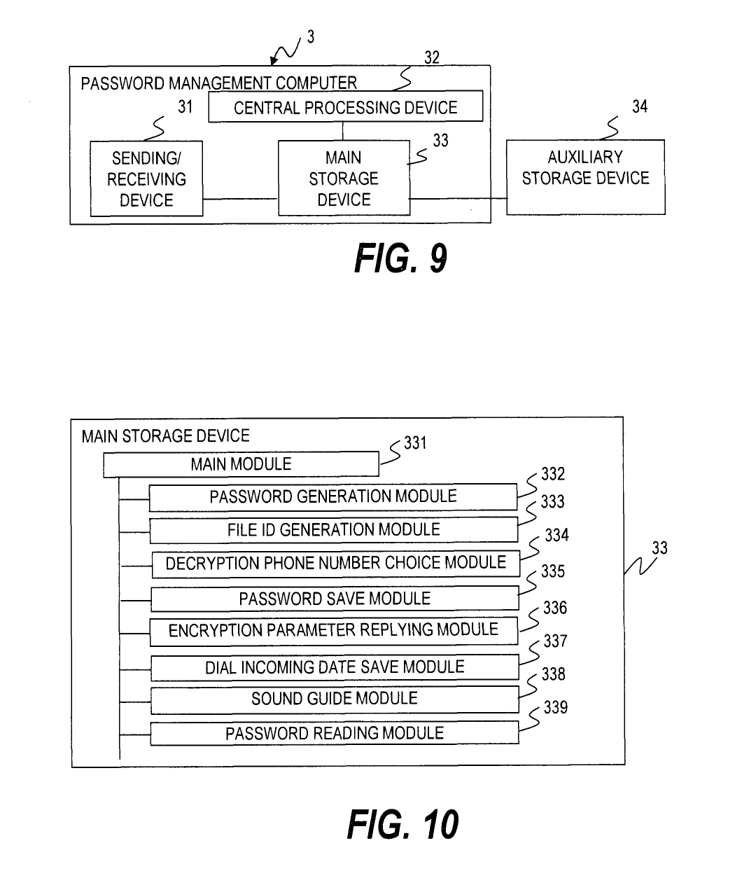

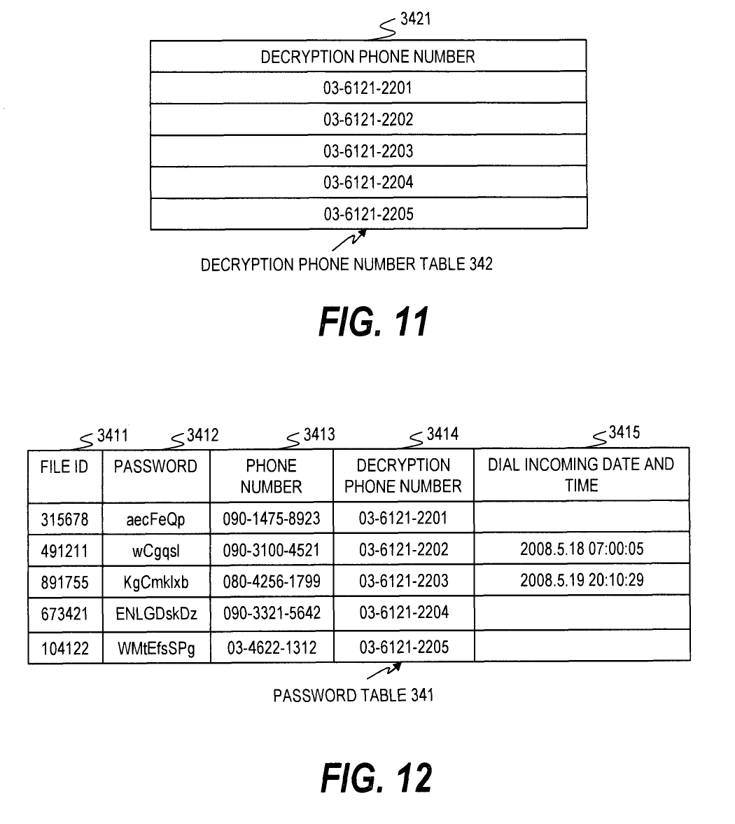

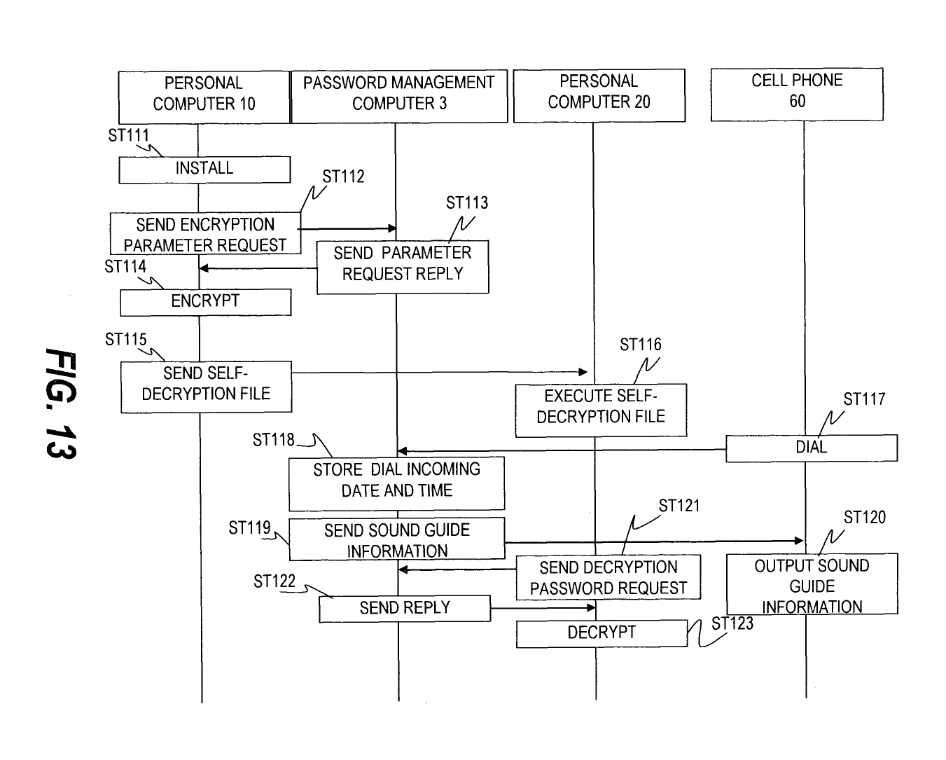

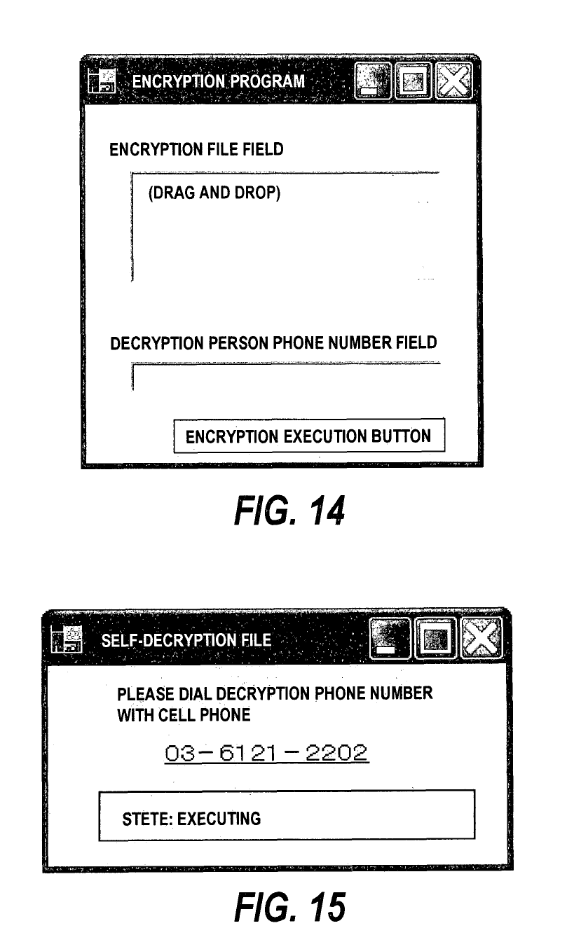

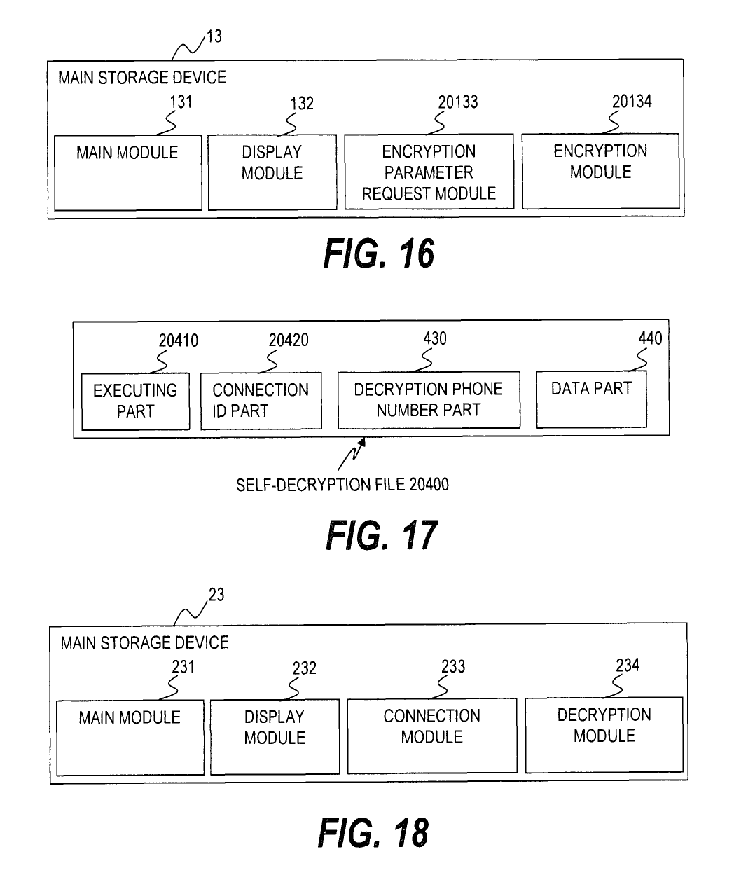

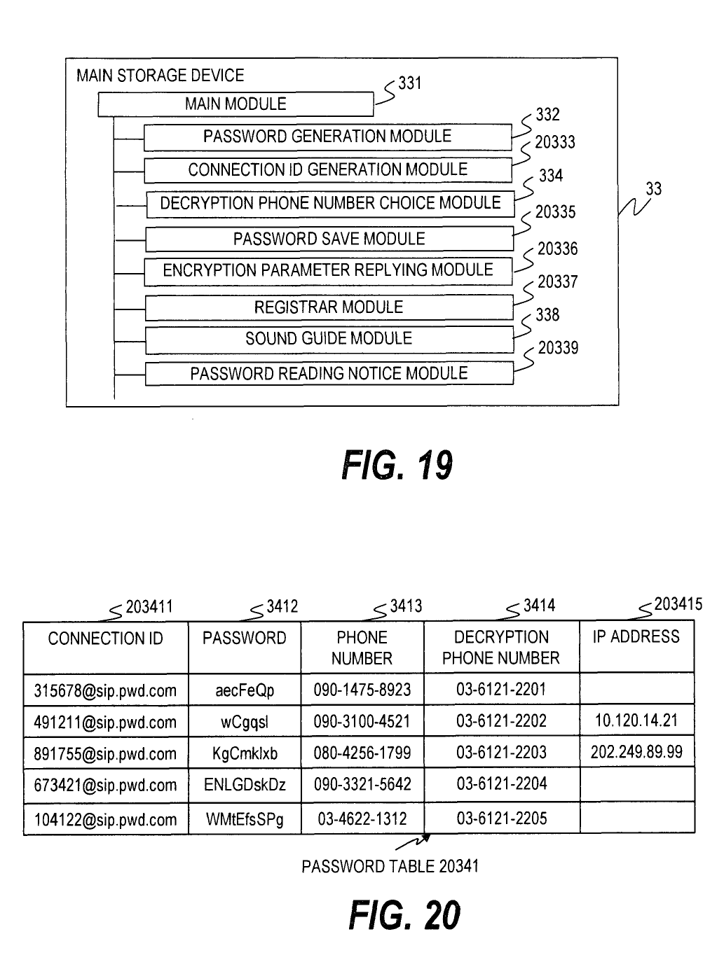

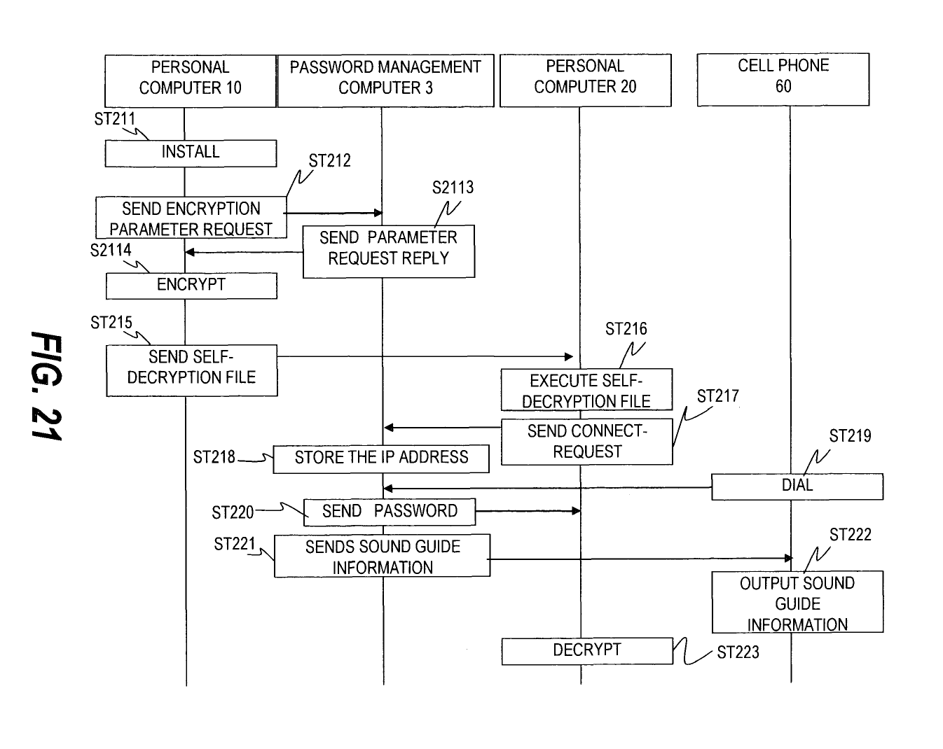

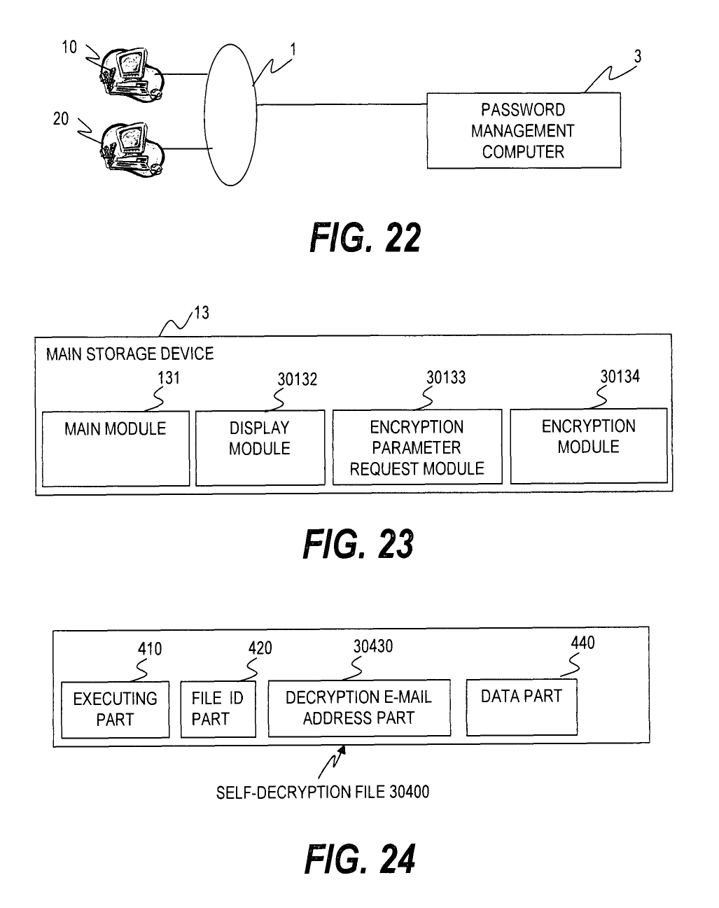

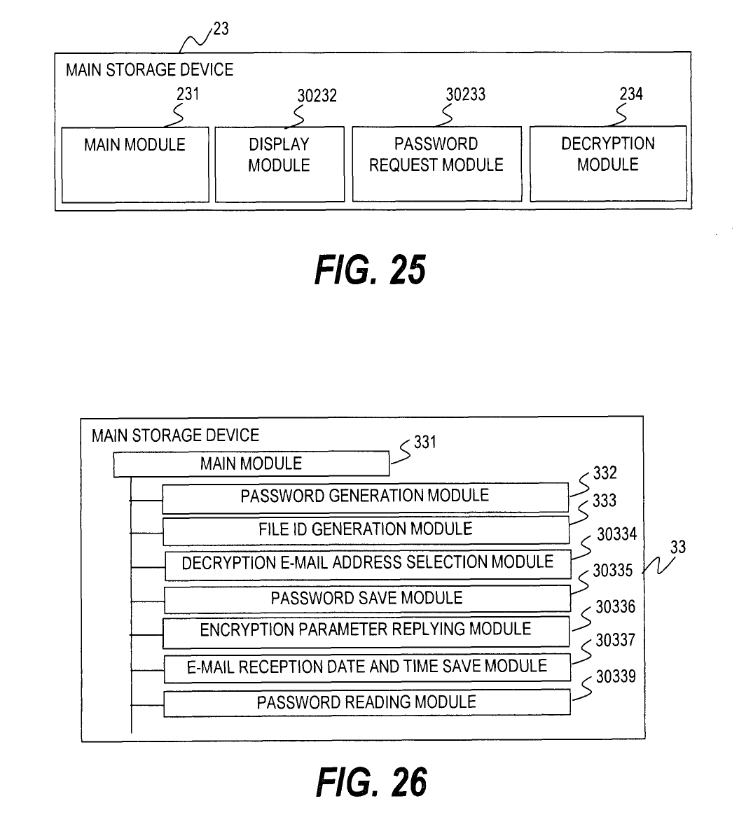

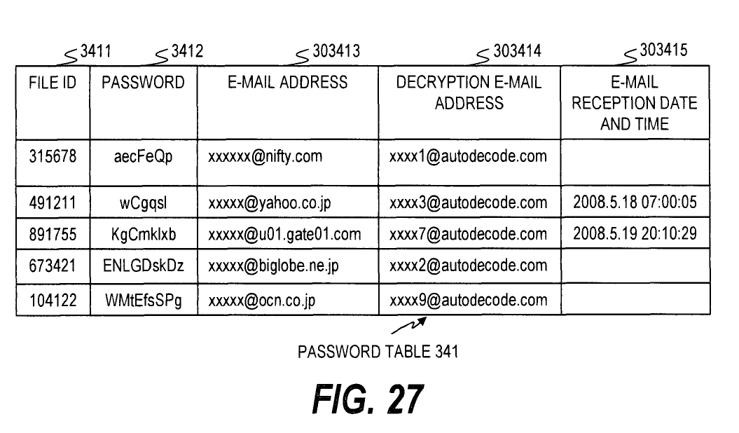

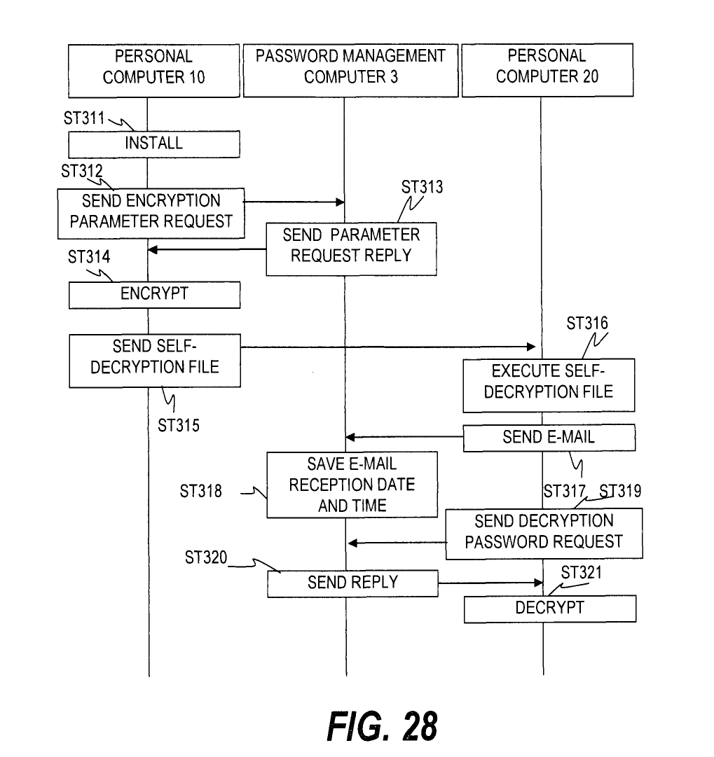

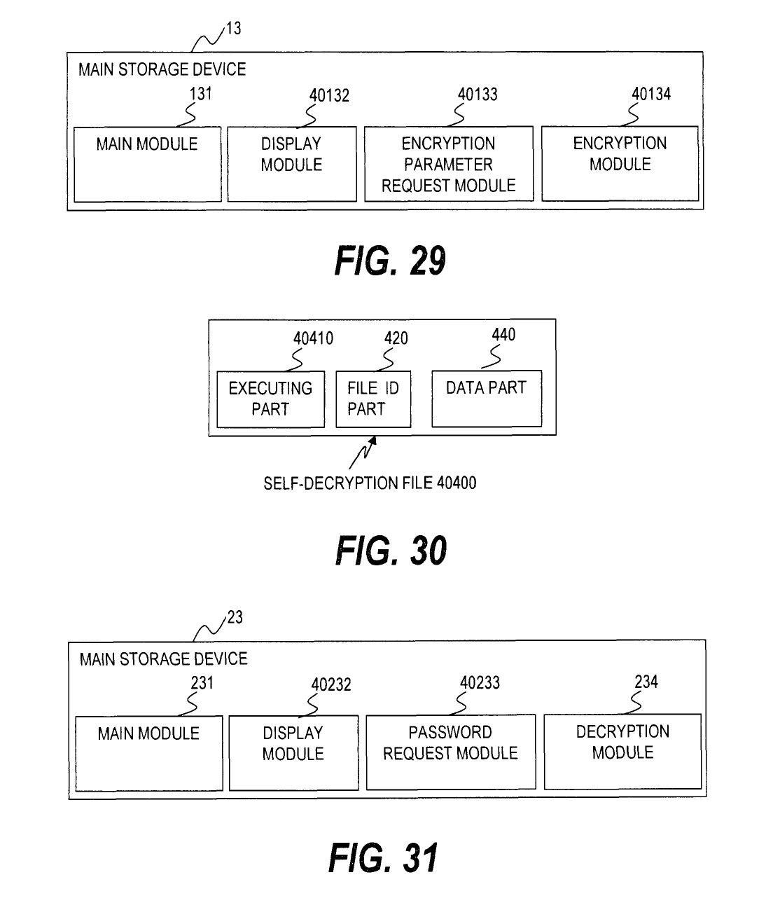

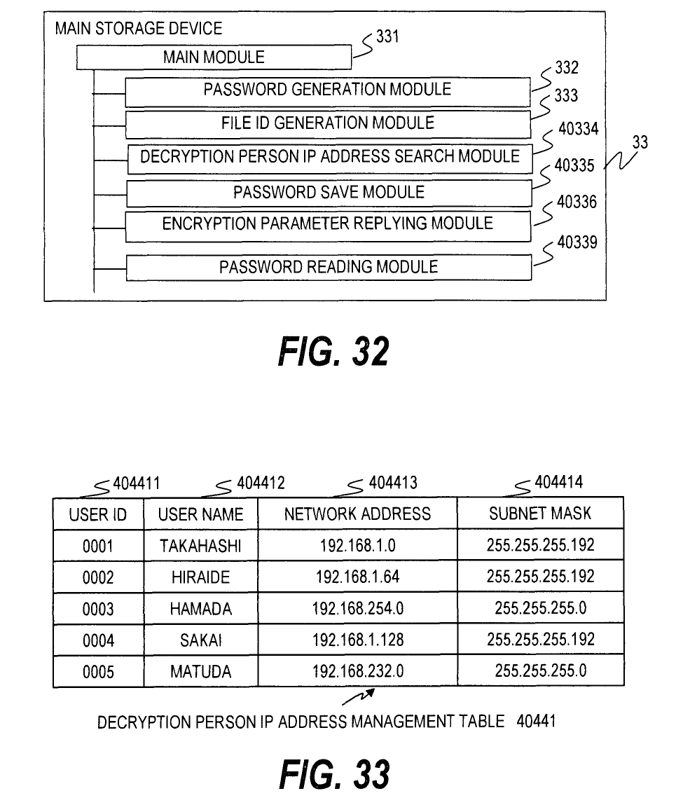

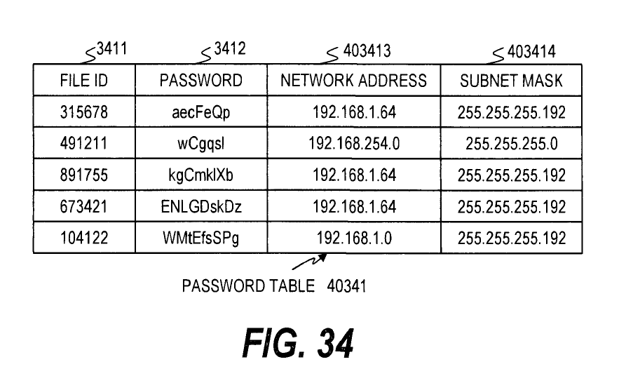

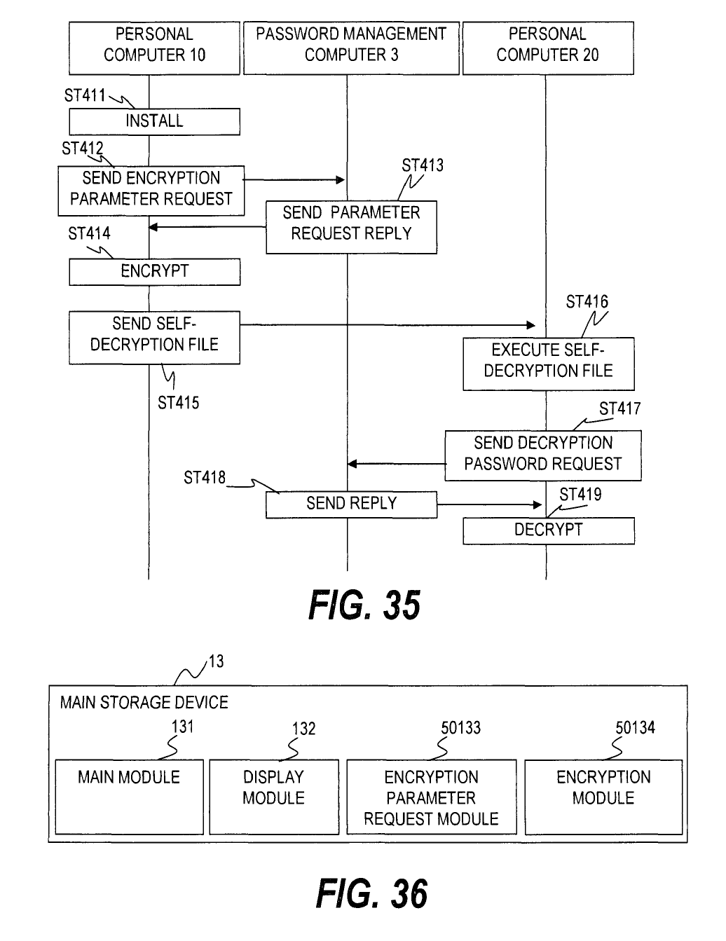

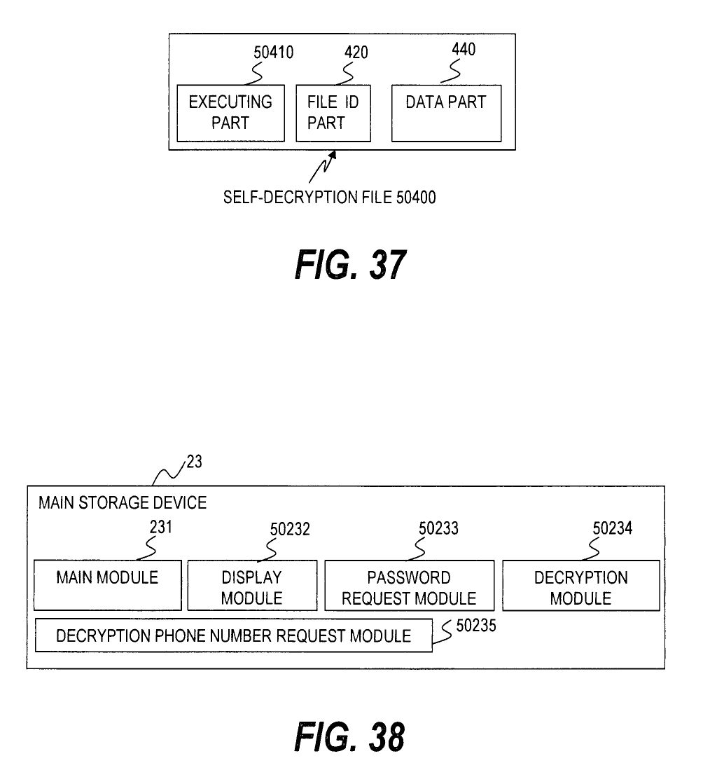

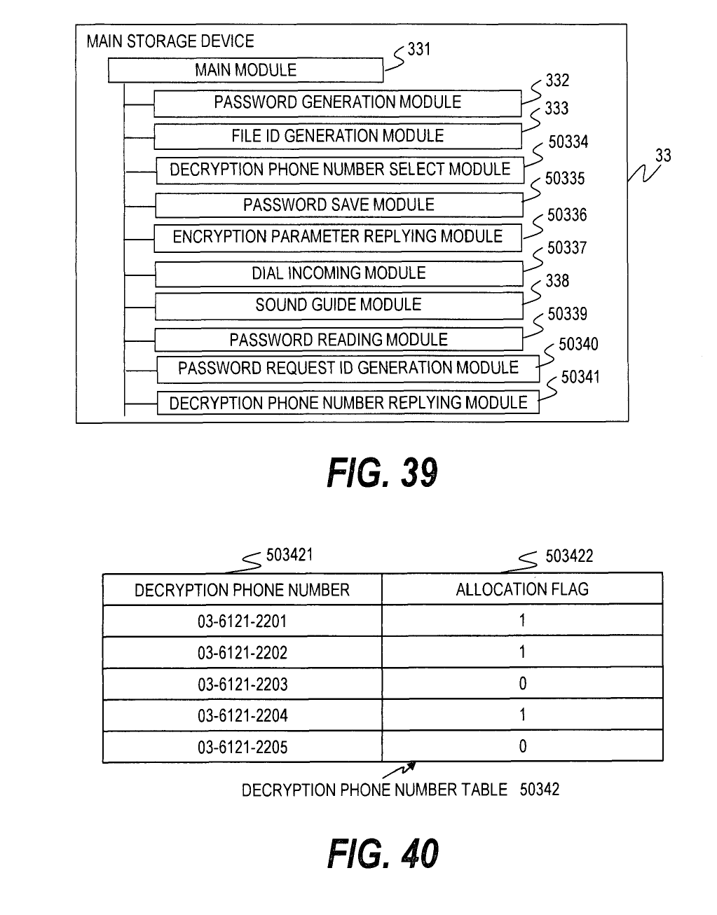

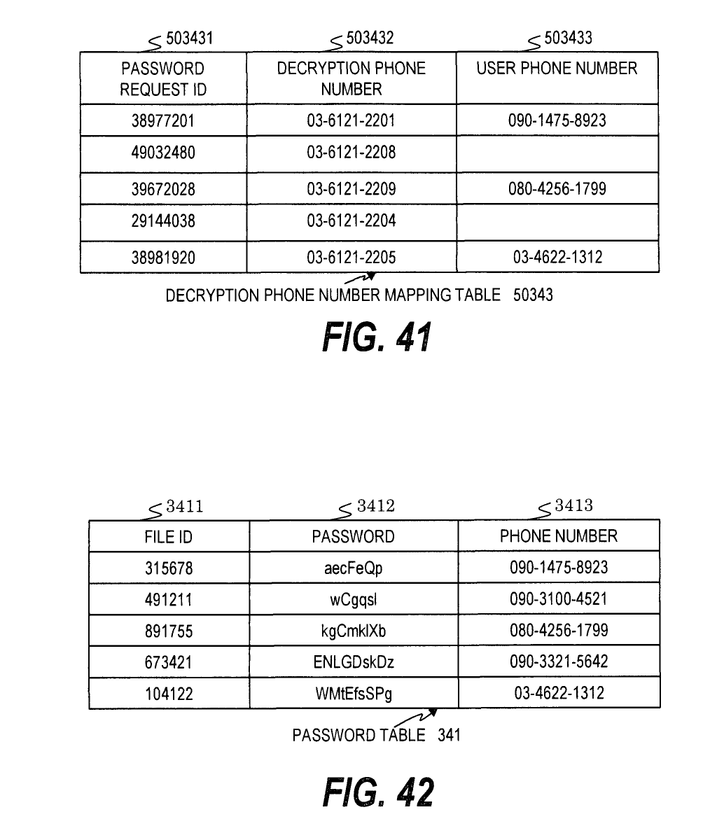

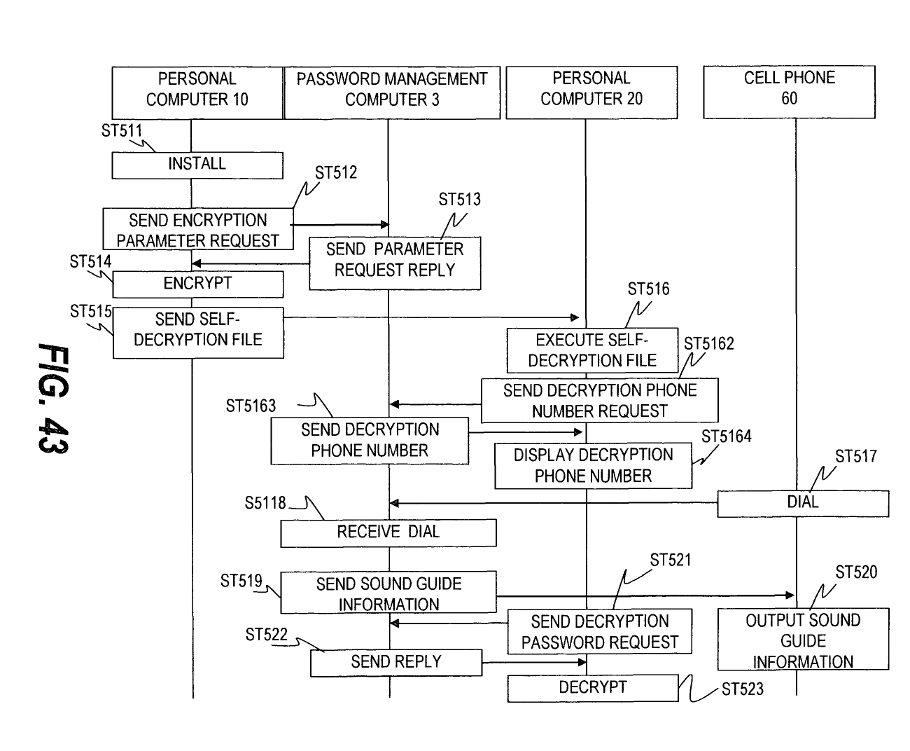

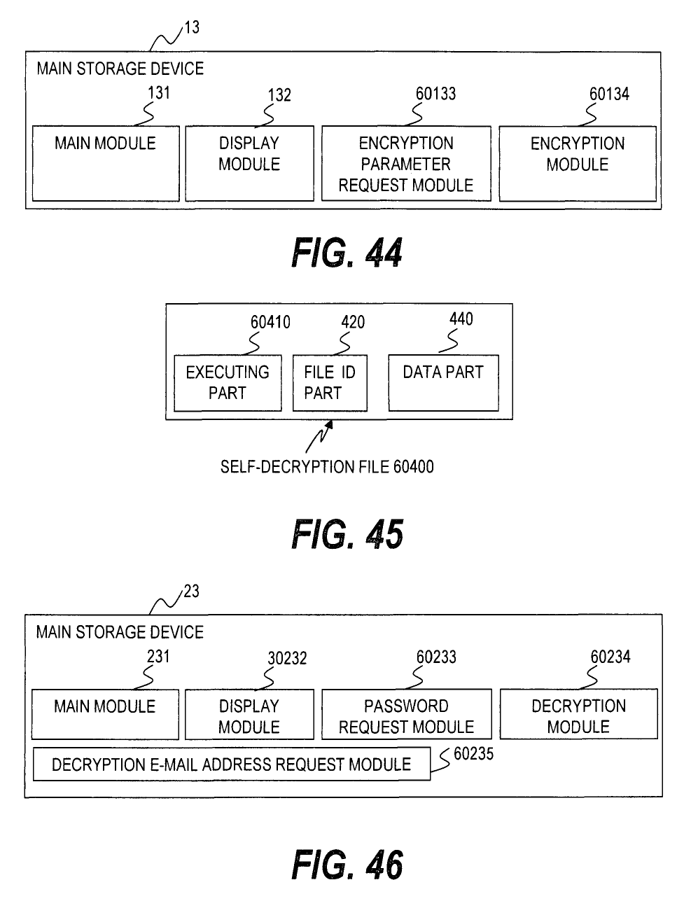

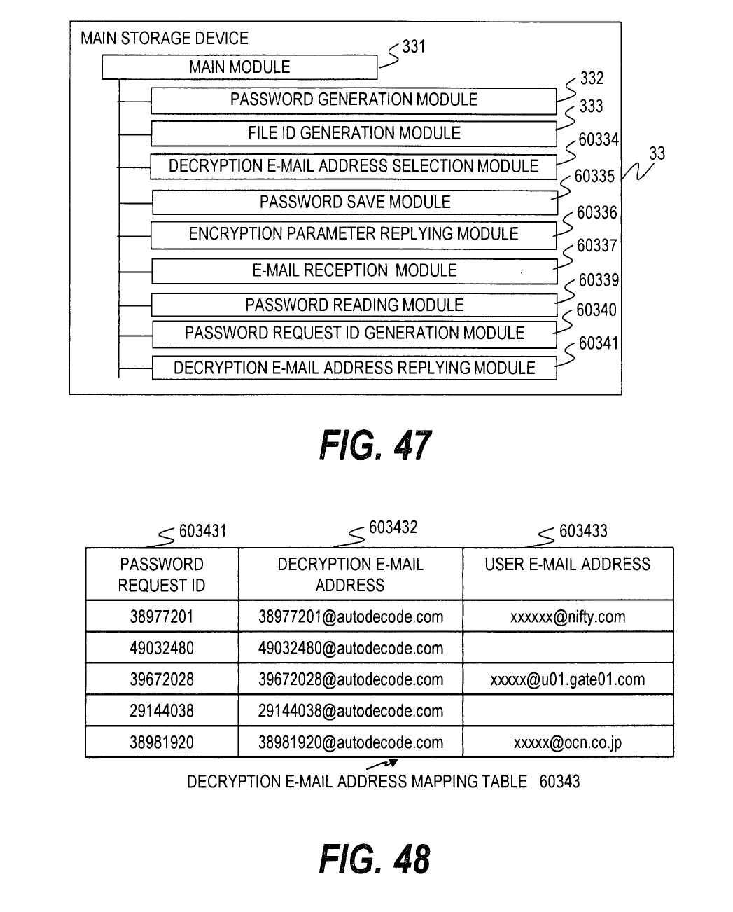

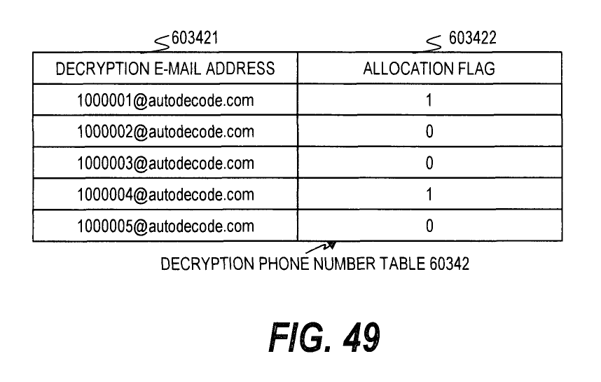

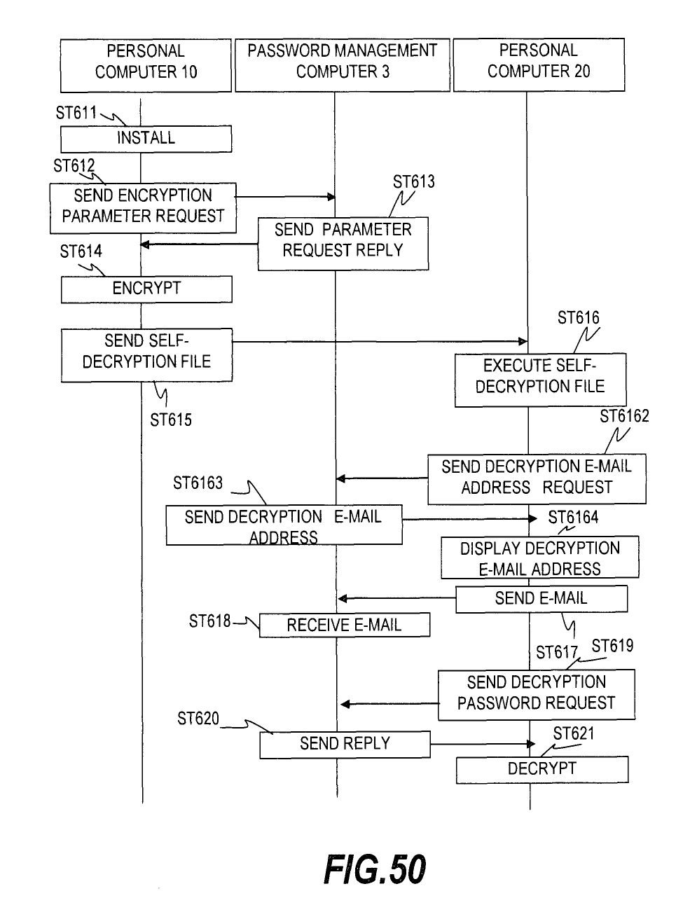

### REFERENCE NUMERALS

1 Internet
10 personal computer
1000 encryption program
11 sending/receiving device
12 central processing device
13 main storage device
131 main module
132 display module
133 encryption parameter request module
134 encryption module
14 auxiliary storage device
2 telephone switched network
20 personal computer
2000 encryption program
20133 encryption parameter request module
20134 encryption module
20233 connection module
20333 connection ID generation module
20335 password save module
20336 encryption parameter replying module
20337 registrar module
20339 password reading notice module
20341 connection ID
20341 password table
203411 connection ID
203415 IP address
20400 self-decryption file
20410 executing part
20420 connection ID part
21 sending/receiving device
22 central processing device
23 main storage device
231 main module
232 display module
233 password request module
234 decryption module
24 auxiliary storage device
3 password management computer
3000 encryption program
3013 display module
30133 encryption parameter request module
30134 encryption module
30232 display module
30233 password request module
30334 decryption e-mail address selection module
30335 password save module
30336 encryption parameter replying module
30337 e-mail reception date and time save module
30339 password reading module
30341 password table
303413 e-mail address
303414 decryption e-mail address
303415 e-mail reception date and time
30400 self-decryption file
30410 executing part
30430 decryption e-mail address part
31 sending/receiving device
32 central processing device
33 main storage device
331 main module
332 decryption e-mail address part 30430
333 file ID generation module
334 decryption phone number choice module
335 password save module
336 encryption parameter replying module
337 dial incoming date save module
338 sound guide module
339 password reading module
34 auxiliary storage device
341 password table
3411 file ID
3412 password
3413 phone number
3414 decryption phone number
3415 dial incoming date and time
342 decryption phone number table
3421 decryption phone number
400 self-decryption file
4000 encryption program
4013 display module
40133 encryption parameter request module
40134 encryption module
40232 display module
40233 password request module
403339 password reading module
40334 decryption person IP address search module
40335 password save module
40336 encryption parameter replying module
40339 password reading module
40341 password table
403413 network address
403414 subnet mask
40400 self-decryption file
40410 executing part
40431 password table
40441 decryption person IP address management table
404411 user ID
404412 user name
404413 network address
404414 subnet mask
410 executing part
420 file ID part
430 decryption phone number part
440 data part
50 regular phone
5000 encryption program
5013 encryption parameter request module
50134 encryption module
50232 display module
50233 password request module
50235 decryption phone number request module
50334 decryption phone number select module
50335 password save module
50336 encryption parameter replying module
50337 dial incoming module
50339 password reading module
50340 password request ID generation module
50341 decryption phone number replying module
50342 decryption phone number table
503421 decryption phone number
503422 allocation flag
50343 decryption phone number mapping table
503431 password request ID
503432 decryption phone number
503433 user phone number
50400 self-decryption file
50410 executing part
60 cell phone
6000 encryption program
6013 encryption parameter request module
60134 encryption module
60233 password request module
60235 decryption e-mail address request module
60334 decryption e-mail address creating module
60335 password save module
60336 encryption parameter replying module
60337 e-mail reception module
60339 password reading module
60341 decryption e-mail address replying module
60342 decryption e-mail address table
603421 decryption e-mail address
603422 allocation flag
60343 decryption e-mail address mapping table
603431 password request ID
603432 decryption e-mail address
603433 user e-mail address
60400 self-decryption file
60410 executing part
61 control device
62 sending/receiving device
63 display device
64 input device
65 mike device
66 speaker device
80 regular phone

1-25. (canceled)

26. An encrypted file delivery system, comprising:
at least one first computer including a processor, a memory, and an interface;
at least one second computer including a processor, a memory, and an interface; and
a password management computer including a processor, a memory, and an interface,
the password management computer coupled to the first computer and the second computer via a network:
wherein the first computer encrypts a file;
wherein the password management computer stores a password information which includes a correspondence relation between a decryption password for decrypting the encrypted file and a phone number allocated an user of the second computer;
wherein the password management computer receives a call with a caller ID;
wherein the password management computer receives a decryption password request;
wherein the password management computer specifies the decryption password demanded by the received decryption password request;
wherein the password management computer refers to the password information so as to specify the phone number corresponding to the specified decryption password;
wherein the password management computer judges whether the call whose caller ID is the specified phone number has been received or not;
wherein the password management computer sends the specified decryption password to the second computer in the case where the call whose caller ID is the specified phone number has been received; and
wherein the second computer decrypts the encrypted file by using the decryption password sent by the password management computer.

27. An encrypted file delivery system, comprising:
at least one first computer including a processor, a memory, and an interface;
at least one second computer including a processor, a memory, and an interface; and
a password management computer including a processor, a memory, and an interface,
the password management computer coupled to the first computer and the second computer via a network:
wherein the first computer encrypts a file;
wherein the password management computer stores a password information which includes a correspondence relation between a decryption password for decrypting the encrypted file and an e-mail address allocated an user of the second computer;
wherein the password management computer receives an e-mail;
wherein the password management computer receives a decryption password request;
wherein the password management computer specifies the decryption password demanded by the received decryption password request;
wherein the password management computer refers to the password information so as to specify the e-mail address corresponding to the specified decryption password;
wherein the password management computer judges whether the e-mail whose source address is the specified e-mail address has been received or not;
wherein the password management computer sends the specified decryption password to the second computer in the case where the e-mail whose source address is the specified e-mail address has been received; and
wherein the second computer decrypts the encrypted file by using the decryption password sent by the password management computer.

28. An encrypted file delivery system, comprising:
at least one first computer including a processor, a memory, and an interface;
at least one second computer including a processor, a memory, and an interface; and
a password management computer including a processor, a memory, and an interface,
the password management computer coupled to the first computer and the second computer via a network:
wherein the first computer encrypts a file;
wherein the password management computer stores a password information which includes a correspondence relation between a decryption password for decrypting the encrypted file and unique information allocated an user of the second computer;
wherein the password management computer receives the unique information;
wherein the password management computer refers to the password information so as to specify the decryption password corresponding to the received unique information;
wherein the password management computer sends the specified decryption password to the second computer; and
wherein the second computer decrypts the encrypted file by using the decryption password sent by the password management computer.

29. An encrypted file delivery system, comprising:
at least one first computer including a processor, a memory, and an interface;
at least one second computer including a processor, a memory, and an interface; and
a password management computer including a processor, a memory, and an interface,
the password management computer coupled to the first computer and the second computer via a network:
wherein the first computer encrypts a file;
wherein the password management computer stores a password information which includes a correspondence relation between a decryption password for decrypting the encrypted file and an user agent address allocated an user of the second computer;
wherein the password management computer receives a signaling;
wherein the password management computer receives a decryption password request;
wherein the password management computer specifies the decryption password demanded by the received decryption password request;
wherein the password management computer refers to the password information so as to specify the user agent address corresponding to the specified decryption password;
wherein the password management computer judges whether the signaling whose source address is the specified user agent address has been received or not;
wherein the password management computer sends the specified decryption password to the second computer in the case where the signaling whose source address is the specified user agent address has been received; and
wherein the second computer decrypts the encrypted file by using the decryption password sent by the password management computer.

30. The encrypted file delivery system according to claim 26,
wherein the first computer attaches to the encrypted file an execution module decrypting the encrypted file; and
wherein the second computer executes the execution module attached to the encrypted file so as to decrypt the encrypted file.

31. The encrypted file delivery system according to claim 27,
wherein the first computer attaches to the encrypted file an execution module decrypting the encrypted file; and
wherein the second computer executes the execution module attached to the encrypted file so as to decrypt the encrypted file.

32. The encrypted file delivery system according to claim 28,
wherein the first computer attaches to the encrypted file an execution module decrypting the encrypted file; and
wherein the second computer executes the execution module attached to the encrypted file so as to decrypt the encrypted file.

33. The encrypted file delivery system according to claim 29,
wherein the first computer attaches to the encrypted file an execution module decrypting the encrypted file; and
wherein the second computer executes the execution module attached to the encrypted file so as to decrypt the encrypted file.

34. The encrypted file delivery system according to claim 26,
wherein the password management computer creates the decryption password and a encryption password for encrypting the file;
wherein the password management computer receives the phone number allocated the user of the second computer from the first computer;
wherein the password management computer stores the correspondence relation between the created decryption password and the received phone number in the password information;
wherein the password management computer sends the created encryption password to the first computer; and
wherein the first computer encrypts the file by using the encryption password which sent by the password management computer.

35. The encrypted file delivery system according to claim 27,
wherein the password management computer creates the decryption password and a encryption password for encrypting the file;
wherein the password management computer receives the e-mail address allocated the user of the second computer from the first computer;
wherein the password management computer stores the correspondence relation between the created decryption password and the received e-mail address in the password information;
wherein the password management computer sends the created encryption password to the first computer; and
wherein the first computer encrypts the file by using the encryption password which sent by the password management computer.

36. The encrypted file delivery system according to claim 29,
wherein the password management computer creates the decryption password and a encryption password for encrypting the file;
wherein the password management computer receives the user agent address allocated the user of the second computer from the first computer;
wherein the password management computer stores the correspondence relation between the created decryption password and the received user agent address in the password information;
wherein the password management computer sends the created encryption password to the first computer; and
wherein the first computer encrypts the file by using the encryption password which sent by the password management computer.

37. The encrypted file delivery system according to claim 28 wherein the unique information is any one of a vein information, a fingerprint information, the voiceprint information, an ID of a FeliCa card, an identification information of a cell phone, a phone number and an e-mail address.
